(19) United States
(12) Patent Application Publication
(10) Pub. No.: US 2026/0264299 A1
(43) Pub. Date: Sep. 10, 2026

(54) METHODS OF INJECTION MOLDING WITH FILAMENT ADHESIVE AND EQUIPMENT FOR INJECTION MOLDING WITH FILAMENT ADHESIVES

(71) Applicant: 3M INNOVATIVE PROPERTIES COMPANY, St. Paul, MN (US)

(72) Inventors: Eric Cybulski, Woodbury, MN (US); Stephen R. Alexander, Stillwater, MN (US); Shaun M. WEST, St. Paul, MN (US); Jacob D. Young, St. Paul, MN (US); Mark E. Napierala, St. Paul, MN (US); Oliver Lingk, Koeln (DE); Mark F. Schulz, Lake Elmo, MN (US); Ross E. Behling, Woodbury, MN (US); Thomas Q. Chastek, St. Paul, MN (US); Jeffrey C. Sexton, Lakeville, MN (US)

(21) Appl. No.: 19/168,042

(22) PCT Filed: Mar. 27, 2024
(86) PCT No.: PCT/IB2024/052949

§ 371 Date: Sep. 23, 2025

Related U.S. Application Data
(60) Provisional application No. 63/493,074, filed on Mar. 30, 2023.

(51) Int. Cl. B29C 45/14; B29K 33/04; B29K 623/00; B29K 655/02; B29K 677/00

(52) U.S. Cl. CPC B29C 45/14344; B29C 45/14467; B29C 2045/14532; B29K 2033/04; B29K 2623/12; B29K 2655/02; B29K 2677/00; B29K 2905/12; B29K 2995/0098

(57) ABSTRACT

Methods of injection molding of a filament adhesive, where the filament adhesive is a pressure sensitive adhesive. Also, provided is equipment suitable for injection molding of a filament adhesive, where the filament adhesive is a pressure sensitive adhesive.

### BACKGROUND

Filament adhesives include those that use a core/sheath configuration, including adhesives that are dispensed in hot melt form and then cooled to provide a pressure-sensitive adhesive. Using the provided dispensing devices, and optionally with the assistance of a computer, these adhesives can be precisely applied to pre-determined locations on a substrate. The ability to customize the size and shape of a pressure-sensitive adhesive provides improved versatility for manufacturers. A variety of filament adhesives are previously known in the art, for example, at least the following patent applications: PCT Published Patent Application No. US2019/017,162, titled “Core-Sheath Filaments and Methods of Printing an Adhesive;” PCT Published Patent Application No. US2020/003123, titled “Adhesive Compositions, Assemblies and Methods Thereof;” PCT Published Patent Application No. US2020/174,396, titled “Extrudable Pressure-Sensitive Adhesive;” and PCT Published Patent Application No. US2022/134,652, titled “Filament Adhesive Dispenser System.”

### SUMMARY

In one aspect of the invention provides a method of injection molding of a pressure sensitive adhesive. This method comprises: providing a filament adhesive wherein the filament adhesive is a pressure sensitive adhesive; providing a first substrate having a first major surface; providing a liner having at least one hole; providing a mold for holding the first substrate and for forming an adhesive layer; heating the filament adhesive to provide a molten composition; heating the flow channel (usually referred to as “hot runner” in the art) for the molten filament adhesive composition; injection molding the molten filament adhesive composition through the heated flow channel and through at least one hole in the liner; and molding an adhesive layer on the first major surface of the first substrate from the molten filament adhesive composition.

In another aspect, the invention provides another method of injection molding of a pressure sensitive adhesive. This method comprises: providing a filament adhesive wherein the filament adhesive is a pressure sensitive adhesive; providing a first substrate having a first major surface and a first minor surface; providing a liner; providing a mold for holding the first substrate and for forming an adhesive layer, wherein the mold has an flow channel located adjacent to the minor surface; heating the filament adhesive to provide a molten filament adhesive composition; heating the flow channel; injection molding the molten filament adhesive composition through the heated flow channel; and molding an adhesive layer on the first major surface of the first substrate from the molten filament adhesive composition.

Another aspect of the invention provides yet another method of injection molding of a pressure sensitive adhesive. This method comprises: providing a filament adhesive wherein the filament adhesive is a pressure sensitive adhesive; providing a first liner having a first major surface and at least one hole; providing a second liner having a first major surface; providing a mold for holding the first liner and the second liner and for forming an adhesive layer therebetween; heating the filament adhesive to provide a molten filament adhesive composition; heating the flow channel; injection molding the molten filament adhesive composition through the heated flow channel and through the at least one hole in the first liner; and molding an adhesive layer on a first major surface of the first liner and on the first major surface of the second liner from the molten filament adhesive composition.

Another aspect of the invention provides yet another method of injection molding of a pressure sensitive adhesive. This method comprises: providing a filament adhesive wherein the filament adhesive is a pressure sensitive adhesive; providing a first liner having a first major surface; providing a second liner having a first major surface; providing a mold for holding the first liner and the second liner and for forming an adhesive layer therebetween; heating the filament adhesive to provide a molten filament adhesive composition; heating the flow channel; injection molding the molten filament adhesive composition through the heated flow channel between the first liner and the second liner; and molding an adhesive layer on a first major surface of the first liner and on the first major surface of the second liner from the molten filament adhesive composition.

Another aspect of the invention provides another a method of injection molding of a pressure sensitive adhesive. This method comprises: providing a filament adhesive wherein the filament adhesive is a pressure sensitive adhesive; providing a first substrate having a first major surface and a first minor surface; providing a second substrate having a first major surface and a first minor surface; providing a mold for holding the first substrate and the second substrate and for forming an adhesive layer therebetween; heating the filament adhesive to provide a molten filament adhesive composition; heating the flow channel; injection molding the molten filament adhesive composition through the heated flow channel and between the major surfaces of the first and second substrate; molding an adhesive layer on a first major surface of the first substrate and on the first major surface of the second substrate from the molten filament adhesive composition.

Another aspect of the invention provides a method of injection molding of a pressure sensitive adhesive. This method comprises: providing a filament adhesive wherein the filament adhesive is a pressure sensitive adhesive; providing a first substrate having a first major surface and at least one hole; providing a second substrate having a first major surface and a first minor surface; providing a mold for holding the first substrate and the second substrate and for forming an adhesive layer therebetween; heating the filament adhesive to provide a molten filament adhesive composition; heating the flow channel; injection molding the molten filament adhesive composition through the heated flow channel and through the at least one hole in the first substrate; molding an adhesive layer on a first major surface of the first liner and on the first major surface of the second liner from the molten filament adhesive composition.

Another aspect of the invention provides an alternative method of injection molding of a pressure sensitive adhesive. This method comprises: providing a filament adhesive wherein the filament adhesive is a pressure sensitive adhesive; providing at least one thermoplastic material for molding at least one substrate; providing at least a first mold for molding the substrate and thereafter forming an adhesive layer on the substrate; injection molding the thermoplastic material into the first mold to form a first substrate having a first major surface; heating the filament adhesive to provide a molten filament adhesive composition; heating the flow channel; injection molding the molten filament adhesive composition through the heated flow channel; and molding an adhesive layer on a first major surface of the first substrate from the molten filament adhesive composition.

Yet another aspect of the invention provides a method of injection molding of a pressure sensitive adhesive, comprising: providing a filament adhesive wherein the filament adhesive is a pressure sensitive adhesive; providing a thermoplastic material for molding a substrate; providing a first mold for molding the substrate; injection molding the thermoplastic material into the first mold to form a first substrate having a first major surface; providing a second mold for holding the first substrate for forming an adhesive layer; heating the filament adhesive to provide a molten filament adhesive composition; heating the flow channel; injection molding the molten filament adhesive composition through the heated flow channel; molding an adhesive layer on a first major surface of the first substrate from the molten filament adhesive composition.

Another aspect of the present invention provides another method of injection molding of a pressure sensitive adhesive. This method comprises: providing a filament adhesive wherein the filament adhesive is a pressure sensitive adhesive; providing a first substrate having a first major surface; providing a liner having at least one hole; providing a mold for holding the first substrate and for forming an adhesive layer; heating the filament adhesive to provide a molten composition; heating a hot runner system; injection molding the molten filament adhesive composition through the heated hot runner system and through the at least one hole in the liner; and molding an adhesive layer on the first major surface of the first substrate from the molten filament adhesive composition.

Another aspect of the invention provides an alternative method of injection molding of a pressure sensitive adhesive. This method comprises: providing a filament adhesive wherein the filament adhesive is a pressure sensitive adhesive; providing a first substrate having a first major surface and a first minor surface; providing a liner; providing a mold for holding the first substrate and for forming an adhesive layer, wherein the mold has an flow channel located adjacent to the minor surface; heating the filament adhesive to provide a molten filament adhesive composition; heating a hot runner system; injection molding the molten filament adhesive composition through the hot runner system and into the flow channel; and molding an adhesive layer on the first major surface of the first substrate from the molten filament adhesive composition.

Another aspect of the invention provides a method of injection molding of a pressure sensitive adhesive. This method comprises: providing a filament adhesive wherein the filament adhesive is a pressure sensitive adhesive; providing a first liner having a first major surface and at least one hole; providing a second liner having a first major surface; providing a mold for holding the first liner and the second liner and for forming an adhesive layer therebetween; heating the filament adhesive to provide a molten filament adhesive composition; heating a hot runner system; injection molding the molten filament adhesive composition through the hot runner system and through the at least one hole in the first liner; and molding an adhesive layer on a first major surface of the first liner and on the first major surface of the second liner from the molten filament adhesive composition.

Another aspect of the invention provides a method of injection molding of a pressure sensitive adhesive. This method comprises: providing a filament adhesive wherein the filament adhesive is a pressure sensitive adhesive; providing a first liner having a first major surface; providing a second liner having a first major surface; providing a mold for holding the first liner and the second liner and for forming an adhesive layer therebetween; heating the filament adhesive to provide a molten filament adhesive composition; heating a hot runner system; injection molding the molten filament adhesive composition through the hot runner system and between the first liner and the second liner; and molding an adhesive layer on a first major surface of the first liner and on the first major surface of the second liner from the molten filament adhesive composition.

In yet another aspect of the invention, the invention provides a method of injection molding of a pressure sensitive adhesive. The method comprises: providing a filament adhesive wherein the filament adhesive is a pressure sensitive adhesive; providing a first substrate having a first major surface and a first minor surface; providing a second substrate having a first major surface and a first minor surface; providing a mold for holding the first substrate and the second substrate and for forming an adhesive layer therebetween; heating the filament adhesive to provide a molten filament adhesive composition; heating the hot runner system; injection molding the molten filament adhesive composition through the hot runner system and between the major surfaces of the first and second substrate; and molding an adhesive layer on a first major surface of the first substrate and on the first major surface of the second substrate from the molten filament adhesive composition.

In another aspect of the invention, the invention provides a method of injection molding of a pressure sensitive adhesive. The method comprises: providing a filament adhesive wherein the filament adhesive is a pressure sensitive adhesive; providing a first substrate having a first major surface and at least one hole;
providing a second substrate having a first major surface and a first minor surface; providing a mold for holding the first substrate and the second substrate and for forming an adhesive layer therebetween; heating the filament adhesive to provide a molten filament adhesive composition; heating the hot runner system; injection molding the molten filament adhesive composition through the hot runner system and through the at least one hole in the first substrate; molding an adhesive layer on a first major surface of the first liner and on the first major surface of the second liner from the molten filament adhesive composition.

In another aspect of the invention, the invention provides a method of injection molding of a pressure sensitive adhesive. This method comprises: providing a filament adhesive wherein the filament adhesive is a pressure sensitive adhesive; providing a thermoplastic material for molding a substrate; providing a first mold for molding the substrate and thereafter forming an adhesive layer on the substrate; injection molding the thermoplastic material into the first mold to form a first substrate having a first major surface; heating the filament adhesive to provide a molten filament adhesive composition; heating a hot runner system; injection molding the molten filament adhesive composition through the hot runner system; and molding an adhesive layer on a first major surface of the first substrate from the molten filament adhesive composition.

Lastly, in another aspect of the invention, the invention provides a method of injection molding of a pressure sensitive adhesive. This method comprises: providing a filament adhesive wherein the filament adhesive is a pressure sensitive adhesive; providing a thermoplastic material for molding a substrate; providing a first mold for molding the substrate; injection molding the thermoplastic material into the first mold to form a first substrate having a first major surface; providing a second mold for holding the first substrate for forming an adhesive layer; heating the filament adhesive to provide a molten filament adhesive composition; heating a hot runner system; injection molding the molten filament adhesive composition through the hot runner system; and molding an adhesive layer on a first major surface of the first substrate from the molten filament adhesive composition.

The above summary of the present disclosure is not intended to describe each disclosed embodiment or every implementation of the present disclosure. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### BRIEF DESCRIPTION OF THE DRAWINGS

FIG. 1 is a perspective view of a filament adhesive;

FIGS. 2A, 2B, and 2C are schematic views of a system including an injection molding machine and a spool of filament adhesive;

FIG. 3A is a perspective view of the stationary or “A-side” portion of the injection mold taken along line 3A-3A in FIG. 2A;

FIG. 3B is perspective view of the opposite side of the stationary or “A-side portion of the injection mold illustrated in FIG. 3A.

FIG. 4 is perspective view of the moving or “B-side” portion of the injection mold taken along line 4-4 in FIG. 2A;

FIGS. 5A-5D are top view of various embodiments of release liners;

FIGS. 6A-6B are an exploded perspective view and a cross-sectional view of a substrate with injection molded adhesive and liner;

FIG. 7 is a flow chart of manufacturing steps of injection molding onto a substrate;

FIGS. 8A-8B are an exploded perspective view and a cross-sectional view of a substrate with injection molded adhesive between two liners; and

FIG. 9 is a flow chart of manufacturing steps of injection molding between two liners.

### DETAILED DESCRIPTION

The present application is focused on inventive methods of injection molding pressure sensitive adhesives, in particular those pressure sensitive adhesives that are in a filament format, explained in more detail in the background and below.

Pressure-sensitive adhesives (“PSAs”) are adhesives that are normally tacky at room temperature and can be adhered to a substrate surface by application of light pressure. No solvent, water, or heat is needed to activate the adhesive.

Characteristics of pressure-sensitive adhesives are described in the Encyclopedia of Polymer Science and Engineering, Vol. 13, Wiley-Interscience Publishers (New York, 1988) and Encyclopedia of Polymer Science and Technology, Vol. 1, Interscience Publishers (New York, 1964). Conventionally, a pressure-sensitive adhesive meets the Dahlquist criterion described in DONATAS SATAS, HANDBOOK OF PRESSURE-SENSITIVE ADHESIVE TECHNOLOGY, 2^{nd} ed., p. 172 (1989). This criterion defines a pressure-sensitive adhesive as one having a one-second creep compliance of greater than 1×10⁻⁶ cm²/dyne at its service temperature (for example, at temperatures in a range of from 15° C. to 35° C.).

As used herein, “polymer” refers to a molecule having one or more properties that do not change upon the addition of a single further repeat unit. The polymer can be a homopolymer, copolymer, terpolymer, and the like. The term “copolymer” means that there are at least two monomers used to form the polymer.

As used herein, the term “styrenic” refers to materials, and/or components, and/or copolymers, and/or glassy blocks that are derived from styrene or another mono-vinyl aromatic monomer similar to styrene.

As used herein, the terms “glass transition temperature” and “T_{g}” are used interchangeably and refer to the glass transition temperature of a material or a mixture.

Unless otherwise indicated, glass transition temperature values are determined by Differential Scanning calorimetry (DSC).

As used herein, “thermoplastic” refers to a polymer that flows when heated sufficiently above its glass transition point (for an amorphous resin) or above the crystallite melting point (for a semi-crystalline material) and becomes solid when cooled.

The term heated flow channel, heated injection system or “hot-runner” system is defined as a series of heated components, typically electric, but can be liquid heated, which are used to convey molten material in an injection mold.

Introducing pressure-sensitive adhesives into the portfolio of material options for injection molding brings several advantages. Injection molded parts are often subcomponents in more complex products. The PSA provides a simple, convenient, and cost-effective way to assemble the molded parts or join those with other parts. It also allows injection molding companies to easily produce parts with added value. Existing options for assembling parts include attaching PSA die cuts or mechanical fastening. When compared to using PSA die cuts, injection molded PSAs eliminate a process in the supply chain, reduce the inherent waste of die cuts, increase automation, and can provide better bonding between the PSA and part. Also, injection molded PSAs maintain the benefit of very precisely defined geometry, while not being limited to a constant thickness. When compared to mechanical fastening, injection molded PSAs can allow for simplification of the molded part by eliminating features associated with mechanical fasteners (e.g., complex undercuts in the molds or substrates), and also simplify and accelerate the process of bonding parts together.

Pressure-sensitive adhesives (PSAs) have several benefits, when compared to other bonding methods. PSAs can be formulated to have excellent adhesion to low, medium, and high surface energy thermoplastics, without the need for any surface modification (e.g., chemical primers, corona treatment, or flame treatment). When PSAs are covered with a liner they can be stored for extended periods of time, thereby fitting into the existing tiered supply chains of injection molded parts. Liners could be made from films such as a polymeric materials, from paper films or from foils, or some combination thereof. PSAs can also be formulated to have excellent ability to compensate for stresses induced by CTE (coefficient of thermal expansion) mismatch of dissimilar materials. They can also have excellent ability to maintain a bond after being subjected to low angle peel forces and environmental aging (e.g., heat and humidity). They also are good at imparting hermetic sealing between parts, including those of dissimilar materials.

In injection molding, it is particularly advantageous to use hot melt PSAs that require no chemical cross-linking. Many PSAs require formation of covalent bonds via UV irradiation, electron beam, or reactive cross-linking chemicals. Without the covalent cross-linking, the PSAs cannot maintain the bond under static loads, especially at elevated temperatures, such as 70 degrees Celsius. In contrast, a subset of hot melt PSAs do not require covalent cross-linking. Styrenic block copolymers (SBCs) maintain cohesive strength via physical cross-links created by microphase separation. The upper service temperature of styrenic block copolymer formulations can be further increased above 80° C. or higher. The styrenic block copolymer formulations could contain endblock tackifiers, such as polyphenylene oxide (PPO), also referred to as polyphenylene ether or polyarylene ether.

The concept of thermoplastic hot melt PSAs is known in the art. For instance, U.S. Pat. No. 7,591,971, titled “Method for Producing an Adhesive Molded Body,” (Ahlborn) described the general concept of introducing PSAs into injection molding processes. However, in order for PSAs to be practically and commercially feasible, several important steps must be taken. By their nature, PSAs will instantly and strongly bond to themselves and the mold unless steps are taken to prevent this. When PSAs with improved performance are formulated to form stronger bonds to parts, this problem becomes even more significant. There are three key elements to preventing the PSA to bonding to itself, the material feed system, or the mold during the molding process: core-sheath format, release liners, and heated flow channel (or “hot-runner” as it is sometimes referred to in the industry). Additionally, consideration should also be given of injector site location, either on liner side or edge of bond line; chamfering of the mold; and the potential use of multi-shot injection molding.

### Filament Adhesives

Advantageously, the inventive methods herein use filament adhesives. Filament adhesives are adhesives provided in a continuous thread-like configuration. The filament adhesive preferably has a uniform cross-section. Advantageously, a filament adhesive can be fed continuously from a spool into an injection molding apparatus.

Particularly useful filament adhesives 100 have a core-sheath filament configuration. Core-sheath filament materials 100 have a configuration in which a first material (i.e., the core 102) is surrounded by a second material (i.e., the sheath 104). Preferably, the core 102 and the sheath 104 are concentric, sharing a common longitudinal axis. The ends of the core 102 need not be surrounded by the sheath 104.

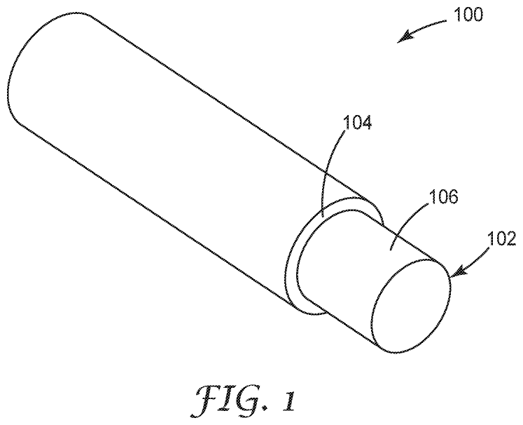

An exemplary filament adhesive is shown in FIG. 1 and hereinafter referred to by the numeral 100. The core-sheath filament adhesive 100 comprises an adhesive core 102 and a non-tacky sheath 104. The adhesive core 102 is a pressure-sensitive adhesive at ambient temperature. As shown, the core 102 has a cylindrical outer surface 106 and the sheath 104 extends around the outer surface 106 of the core 102. The core-sheath filament adhesive 100 has a cross-section that is generally circular as shown here, but it is to be understood that other cross-sectional shapes (e.g., square, hexagonal, or multi-lobed shapes) are also possible. For the methods herein, the non-tacky sheath material 104 typically does not contribute to improving bond performance, and therefore should be minimized to 5% or less of the overall PSA composition.

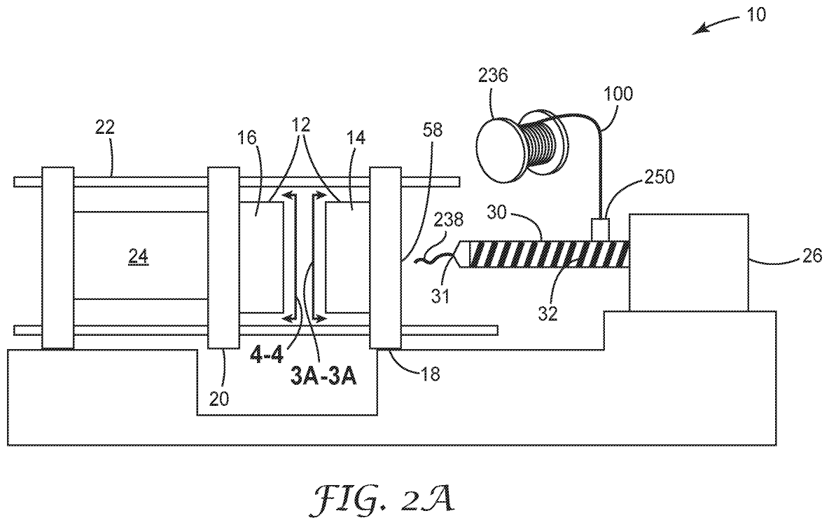

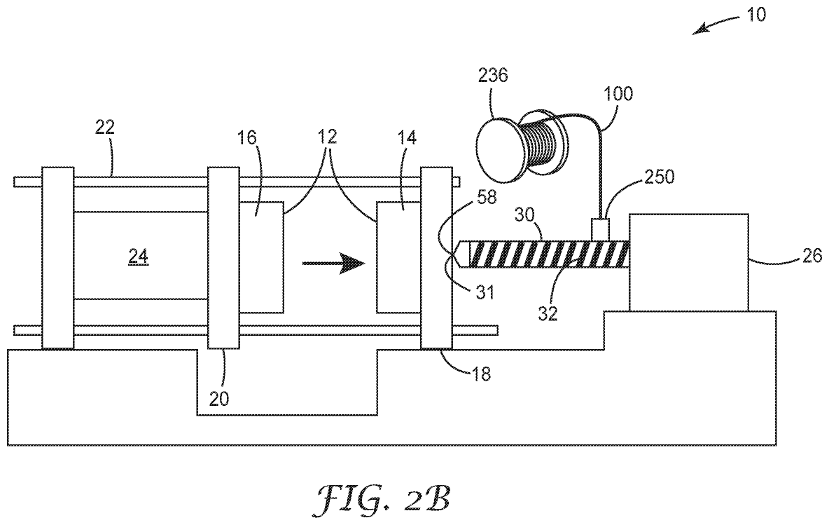

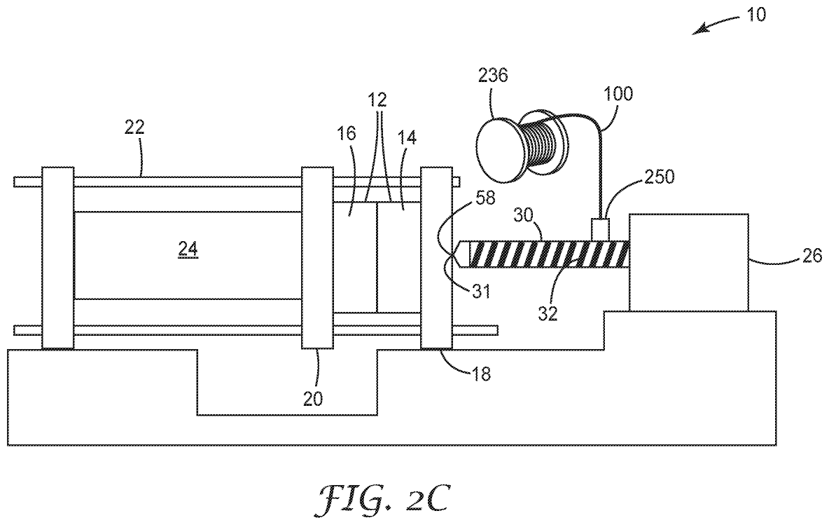

Advantageously, the non-tacky sheath 104 prevents the filament adhesive 100 from sticking to itself, thereby enabling convenient storage and handling of the filament adhesive 100 on a spool (shown as 236 in FIGS. 2A-2C). This allows the filament pressure sensitive adhesive 100 to be wrapped up on itself in a spool 236 without bonding to itself. The filament form factor allows the PSA to be continuously fed directly into the feed section of the molding machine.

The diameter of the core-sheath filament adhesive 100 is not particularly restricted. Although, narrow diameter filaments can wrap around the injection molding screw, feed too slowly at typical screw RPMs (revolutions per minute), and are more prone to breaking, which results in poor ability to feed. Factors that influence the choice of filament diameter include the size constraints on the adhesive dispenser, desired adhesive throughput, and precision requirements for the adhesive application. The core-sheath filament 100 can include an average diameter feasibly ranging from approximately 3 to 25 millimeters (mm), more preferably from 5 to 12 mm, and most preferably 8.5 mm. If the filament diameter is too large, then it will not fit between the screw flights of the injection molding screw (illustrated in FIGS. 2A-2C), and therefore will not continuously feed into the process in a proper way. If the filament diameter is too low, then the relative percent of the sheath 104 material can become too high. The filament adhesive 100 can be a stock item and provided in any length appropriate for the application.

Core-sheath filament adhesives 100 according to the present disclosure can be made using any known method. In an exemplary embodiment, these filament adhesives 100 are made by extruding molten polymers through a coaxial die. Technical details, options and advantages concerning the aforementioned core-sheath filament adhesives 100 are described in PCT Patent Application Publications No. 2019/017162, titled “Core-Sheath Filaments and Methods of Printing an Adhesive,” No. 2020/003123, titled “Adhesive Compositions, Assemblies, and Methods Thereof,” and No. 2020/174396, titled “Extrudable Pressure-Sensitive Adhesives,” all of which are hereby incorporated by reference. Preferred embodiments of filament PSA for use in the present methods is commercially available from 3M Company based in St. Paul, MN, as 3M™ VHB™ Extrudable Tape.

For the filament adhesives 100 suitable for use in the methods described herein, the adhesive core 102 typically makes up 50 wt. % or more of the total core-sheath filament adhesive 100, 55 wt. % or more, 60 wt. % or more, 65 wt. % or more, 70 wt. % or more, 75 wt. % or more, 80 wt. % or more, 85 wt. % or more, or even 90 wt. % or more of the total weight of the core-sheath filament 100; and 96 wt. % or less, 94 wt. % or less, 90 wt. % or less, 85 wt. % or less, 80 wt. % or less, 70 wt. % or less, or 65 wt. % or less of the total weight of the core-sheath filament adhesive 100. Stated another way, the core 102 can be present in an amount of 50 wt. % to 96 wt. % of the core-sheath filament adhesive 100, 60 to 90 wt. %, 70 to 90 wt. %, 50 to 70 wt. %, or 80 to 96 wt. % of the core-sheath filament adhesive 100. In some embodiments the total core-sheath filament adhesive 100 could contain 96 wt. % for the adhesive core 102 and 4 wt. % for sheath 104.

The adhesive core 102 can be made using a number of different chemistries, including for instance, styrenic block copolymers, (meth)acrylics, (meth)acrylic block copolymers, natural rubber, styrene butadiene rubber, butyl rubber, polyisobutylene, ethylene vinyl acetate, amorphous poly(alpha-olefins), silicones, polyvinyl ether, polyisoprene, polybutadiene, butadiene-acrylonitrile rubber, polychoroprene, polyurethane, polyvinylpyrrolidone, or combinations thereof.

In many embodiments, the adhesive core 102 comprises a styrenic block copolymer and a tackifier. Any number of styrenic block copolymers can be incorporated into the adhesive core 102; one, two, three, four, or even more different styrenic block copolymers may be included in the adhesive core 102. In some embodiments, a suitable styrenic block copolymer comprises a copolymer of a (meth)acrylate with a styrene macromer. In select embodiments, the adhesive core 102 comprises a (meth)acrylic polymer.

A suitable styrenic block copolymer has at least one rubbery block and two or more glassy blocks. The styrenic block copolymer is often a linear block copolymer of general formula (G-R)ₘ-G where G is a glassy block, R is a rubbery block, and m is an integer equal to at least 1. Variable m can be, for example, in a range of 1 to 10, in a range of 1 to 5, in a range of 1 to 3, or equal to 1. In many embodiments, the linear block copolymer is a triblock copolymer of formula G-R-G where the variable m in the formula (G-R)ₘ-G is equal to 1. Alternatively, a suitable styrenic block copolymer can be a radial (i.e., multi-arm) block copolymer of general formula (G-R)ₙ—Y where each R and G are the same as defined above, n is an integer equal to at least 3, and Y is the residue of a multifunctional coupling agent used in the formation of the radial block copolymer. The variable n represents the number of arms in the radial block copolymer and can be at least 4, at least 5, or at least 6 and often can be up to 10 or higher, up to 8, or up to 6. For example, the variable n is in a range of 3 to 10, in a range of 3 to 8, or in a range of 3 to 6.

Alternatively, the styrenic block copolymer can be a star (also known as a radial or multi-arm) block copolymer of general formula (G-R)ₙ—Y where each R and G are the same as defined above, n is an integer equal to at least 3, and Y is the residue of a multifunctional coupling agent used in the formation of the star block copolymer. The variable n represents the number of arms in the star block copolymer and can be from 3 to 10, from 3 to 8, from 3 to 6, or in some embodiments, less than, equal to, or greater than 3, 4, 5, 6, 7, 8, 9, or 10.

In both the linear block copolymer and radial block copolymer versions of the styrenic block copolymer, the glassy blocks G can have the same or different molecular weight. Similarly, if there is more than one rubbery block R, the rubbery blocks can have the same or different molecular weights.

Generally, each rubbery block has a glass transition temperature (T_{g}) that is less than room temperature. For example, the glass transition temperature is often less than 20° C., less than 0° C., less than −10° C., or less than −20° C. In some examples, the glass transition temperature is less than −40° C. or even less than −60° C. The glass transition temperature can be determined using conventional methods known in the art, including Differential Scanning Calorimetry or Dynamic Mechanical Analysis.

Each rubbery block R in the linear or radial block copolymers is typically the polymerized product of a first polymerized conjugated diene, a hydrogenated derivative of a polymerized conjugated diene, or a combination thereof. The conjugated diene often contains 4 to 12 carbon atoms. Example conjugated dienes include, but are not limited to, butadiene, isoprene, 2-ethylbutadiene, 1-phenylbutadiene, 1,3-pentadiene, 1,3-hexadiene, 2,3-dimethyl-1,3-butadiene, and 3-ethyl-1,3-hexadiene.

Each rubbery block R can be a homopolymer or copolymer. The rubbery block R is often poly(butadiene), poly(isoprene), poly(2-ethylbutadiene), poly(1-phenylbutadiene), poly(1,3-pentadiene), poly(1,3-hexadiene), poly(2,3-dimethyl-1,3-butadiene), poly(3-ethyl-1,3-hexadiene), poly(ethylene/propylene), poly(ethylene/butylene), poly(isoprene/butadiene), or the like. In many embodiments, the block R is polybutadiene, polyisoprene, poly(isoprene/butadiene), poly(ethylene/butylene), or poly(ethylene/propylene).

The glass transition temperature of each glassy block G is generally at least 50° C., at least 60° C., at least 70° C., at least 80° C., at least 90° C., or even at least 100° C.

Each glassy block G in the linear or radial block copolymers is typically the polymerized product of a first mono-vinyl aromatic monomer. The mono-vinyl aromatic monomer usually contains, for example, at least 8 carbon atoms, at least 10 carbon atoms, or at least 12 carbon atoms and up to 18 carbon atoms, up to 16 carbon atoms, or up to 14 carbon atoms. Example first mono-vinyl aromatic monomers include, but are not limited to, styrene, vinyl toluene, alpha-methyl styrene, 2,4-dimethyl styrene, ethyl styrene, 2,4-diethyl styrene, 3,5-diethyl styrene, alpha-2-methyl styrene, 4-tert-butyl styrene, 4-isopropyl styrene, and the like.

Each glassy block G can be a homopolymer or a copolymer. The glassy block G is often poly(styrene), poly(vinyl toluene), poly(alpha-methyl styrene), poly(2,4-dimethyl styrene), poly(ethyl styrene), poly(2,4-diethyl styrene), poly(3,5-diethyl styrene), poly(alpha-2-methyl styrene), poly(4-tert-butyl styrene), poly(4-isopropyl styrene), copolymers thereof, and the like.

In many embodiments, each glassy block G is polystyrene homopolymer or is a copolymer derived from a mixture of styrene and a styrene-compatible monomer, which is a monomer that is miscible with styrene. In most cases where the glassy phase is a copolymer, at least 50 weight percent of the monomeric units are derived from styrene. For example, at least 60 weight percent, at least 70 weight percent, at least 80 weight percent, at least 90 weight percent, at least 95 weight percent, at least 98 weight percent, or at least 99 weight percent of the monomeric units in the glassy block G is derived from styrene.

The styrenic block copolymer typically contains at least 5 weight percent and can contain up to 50 weight percent glassy blocks G. If the amount of glassy blocks G is too low, the cohesive strength may be too low because there is not sufficient physical crosslinking. On the other hand, if the amount of glassy blocks G is too high, the modulus may be too high (the composition may be too stiff and/or too elastic) and the resulting composition will not wet out well (spread on a surface such as on a substrate surface) when the molten adhesive is deposited on a substrate. For example, the styrenic copolymer often contains at least 6 weight percent, at least 7 weight percent, at least 8 weight percent, at least 9 weight percent, or at least 10 weight percent and up to 45 weight percent, up to 40 weight percent, up to 35 weight percent, up to 30 weight percent, up to 25 weight percent, up to 20 weight percent, or up to 15 weight percent glassy blocks G. The weight percent values are based on the total weight of the styrenic block copolymer. The remainder of the weight of the styrenic block copolymer is mainly attributable to the rubbery blocks.

In some embodiments, the styrenic block compound is a linear triblock copolymer and the triblock copolymer typically contains at least 10 weight percent glassy blocks G. For example, the triblock copolymer contains at least 15 weight percent or at least 20 weight percent glassy blocks. The amount of the glassy blocks in the triblock copolymer can be up to 35 weight percent. For example, the triblock copolymer can contain up to 30 weight percent or up to 25 weight percent glassy blocks G. In some examples, the triblock copolymer contains 10 to 35 weight percent, 10 to 30 weight percent, 10 to 25 weight percent, or 10 to 20 weight percent of the glassy blocks. The weight percent values are based on the total weight of the triblock copolymer. The remainder of the weight of the linear triblock copolymer is attributable to the rubbery block. For example, the linear triblock copolymer can contain 10 to 35 weight percent glassy blocks and 65 to 90 weight percent rubbery block, 10 to 30 weight percent glassy block and 70 to 90 weight percent rubbery block, 10 to 25 weight percent glassy block and 75 to 90 weight percent rubbery block, or 10 to 20 weight percent of the glassy blocks and 80 to 90 weight percent rubbery blocks based on a total weight of the linear triblock copolymer.

In addition to the glassy blocks G and the rubbery blocks R, styrenic block copolymers that are radial block copolymers include a multifunctional coupling agent J. The coupling agent often has multiple carbon-carbon double bonds, carbon-carbon triple bonds, or other groups that can react with carbamions of the living polymer used to form the radial block copolymers. The multifunctional coupling agents can be aliphatic, aromatic, heterocyclic, or a combination thereof. Examples include, but are not limited to, polyvinyl acetylene, diacetylene, di(meth)acrylates (e.g., ethylene dimethacrylate), divinyl benzene, divinyl pyridine, and divinyl thiophene. Other examples include, but are not limited to, multi-functional silyl halide (e.g., tetrafunctional silyl halide), polyepoxides, polyisocyanates, polyketones, polyanhydrides, polyalkenyls, and dicarboxylic acid esters.

The weight average molecular weight of the styrenic block copolymer is often no greater than 1,200,000 Daltons (Da). If the weight average molecular weight is too high, the copolymer would be difficult to extrude due to its high melt viscosity and would be difficult to blend with other materials. The weight average molecular weight is often no greater than 1,000,000 Da, no greater than 900,000 Da, no greater than 800,000 Da, no greater than 600,000 Da, or no greater than 500,000 Da. The weight average molecular weight of the styrenic block copolymer is typically at least 75,000 Da. If the weight average molecular weight is too low, the cohesive strength of the resulting adhesive may be unacceptably low. The weight average molecular weight is often at least 100,000 Da, at least 200,000 Da, at least 300,000 Da, or at least 400,000 Da. For example, the styrenic block copolymer can be in the range of 75,000 to 1,200,000 Da, in a range of 100,000 to 1,000,000 Da, in a range of 100,000 to 900,000 Da, or in a range of 100,000 to 500,000 Da. Radial block copolymers often have a higher weight average molecular weight than linear triblock copolymers. For example, in some embodiments, the radial block copolymers have a weight average molecular weight in a range of 500,000 to 1,200,000, in a range of 500,000 to 1,000,000 Da or in a range of 500,000 to 900,000 Da while the linear triblock copolymers have a weight average molecular weight in a range of 75,000 to 500,000 Da, in a range of 75,000 to 300,000 Da, in a range of 100,000 to 500,000 Da, or in a range of 100,000 to 300,000 Da.

Some styrenic block copolymers are polymodal block copolymers. As used herein, the term “polymodal” means that the two or more glassy blocks do not all have the same weight average molecular weight. The polymodal block copolymers are usually “asymmetric”, which means that the arms are not all identical. Such block copolymers can be characterized as having at least one “high” molecular weight glassy block and at least one “low” molecular weight glassy block, wherein the terms high and low are relative to each other. In some embodiments, the ratio of the number average molecular weight of the high molecular weight glassy block (Mn)_{H}, relative to the number average molecular weight of the low molecular weight glassy block (Mn)_{L} is at least 1.25. Methods of making asymmetrical, polymodal styrenic block copolymers are described, for example, in U.S. Pat. No. 5,296,547 (Nestegard et al.).

Some particular styrenic block copolymers have glassy blocks that are polystyrene and one or more rubbery blocks selected from polyisoprene, polybutadiene, poly(isoprene/butadiene), poly(ethylene/butylene), and poly(ethylene/propylene). Some even more particular styrenic block copolymers have glassy blocks that are polystyrene and one or more rubbery blocks selected from polyisoprene and polybutadiene, e.g., styrene butadiene rubber (SBR).

The styrenic block copolymers create physical crosslinks within the adhesive and contribute to the overall elastomeric character of the (e.g., pressure sensitive) adhesive. Typically, higher glassy block levels enhance the amount of physical crosslinking that occurs. More physical crosslinking tends to increase the shear strength of the adhesive.

In addition to the styrenic block copolymer described in detail above, a styrenic diblock copolymer may further be included in the core 102. This second styrenic copolymer can be separately added to the first styrenic block copolymer; however, many commercially available linear styrenic block copolymers (e.g., triblock copolymers) include some styrenic diblock copolymer. The diblock copolymer has a single glassy block G and a single rubbery block R. The diblock copolymer (G-R) can lower the viscosity of the adhesive and/or provide functionality that is typically obtained by addition of a plasticizer. Like a plasticizer, the diblock copolymer can increase the tackiness and low temperature performance of the resulting adhesive. The diblock copolymer also can be used to adjust the flow of the adhesive. The amount of diblock needs to be selected to provide the desired flow characteristics without adversely affecting the cohesive strength of the adhesive.

The same types of glassy blocks G and rubbery blocks R described above for use in the styrenic block copolymer (e.g., triblock and radial block copolymer) can be used for the styrenic diblock copolymer). Often, however, it can be advantageous to not select the same rubbery block for both block copolymers to facilitate the solubility of other components such as the tackifier in the core 102.

The amount of glassy block G in the styrenic diblock copolymer is often at least 10 weight percent based on a weight of the diblock copolymer. In some embodiments, the diblock contains at least 15 weight percent, at least 20 weight percent, or at least 25 weight percent glassy block. The amount of glassy block can be up to 50 weight percent, up 45 weight percent, up to 40 weight percent, up to 35 weight percent, or up to 30 weight percent. For example, the diblock can contain 10 to 50 weight percent, 10 to 40 weight percent, 15 to 50 weight percent, 15 to 40 weight percent, 20 to 50 weight percent or 20 to 40 weight percent glassy block. The weight percent values are based on the total weight of the diblock copolymer. The remainder of the weight of the diblock copolymer is mainly attributable to the rubbery block.

The weight average molecular weight of the styrenic diblock copolymer can be up to 250,000 Da, up to 225,000 Da, up to 200,000 Da, or up to 175,000 Da. If the molecular weight is too high, the diblock copolymer may not function to provide the desired flow characteristics or to provide other desired characteristics such as, for example, reducing the elastic modulus and/or increasing the tackiness of the (e.g., pressure-sensitive) adhesive. The weight average molecular weight is often at least 75,000 Da, at least 100,000 Da, at least 125,000 Da, or at least 150,000 Da. For example, weight average molecular weight of the diblock copolymer can be in a range of 75,000 to 250,000 Da, in a range of 100,000 to 250,000 Da, in a range of 125,000 to 250,000 Da, or in a range of 125,000 to 200,000 Da.

The core 102 often comprises styrenic material containing 0 to 30 weight percent of the styrenic diblock copolymer based on a total weight of all styrenic material present. In some embodiments, there is at least 1 wt. % or at least 5 wt. % and up to 25 wt. %, up to 20 wt. %, up to 15 wt. %, or up to 10 wt. % of the styrenic diblock copolymer. If too much of the diblock is added, the shear strength of the (e.g., pressure-sensitive) adhesive may be undesirably low. In some example core compositions, the styrenic block copolymer having at least one rubbery block and two or more glassy blocks is present in an amount of 70 to 100 wt. % of all styrenic material and the styrenic diblock copolymer is present in an amount of 0 to 30 wt. % of all styrenic material. Stated differently, styrenic material may contain 70 to 100 wt. % of a radial block copolymer and/or linear block copolymer (e.g., linear triblock copolymer) and 0 to 30 wt. % diblock copolymer.

Suitable styrenic materials for use in the core 102, either alone or in combination, are commercially available under the trade designation KRATON (e.g., KRATON D116 P, D1118, D1119, and A1535) from Kraton Performance Polymers (Houston, TX, USA), under the trade designation SOLPRENE (e.g., SOLPRENE S-1205) from Dynasol (Houston, TX, USA), under the trade designation QUINTAC from Zeon Chemicals (Louisville, KY, USA), and under the trade designations VECTOR and TAIPOL from TSRC Corporation (New Orleans, LA, USA).

In select embodiments, the styrenic block copolymer comprises a copolymer of a (meth)acrylate with a styrene macromer. This styrenic copolymer can be separately added to the core 102. Typically, this styrenic copolymer comprises the reaction product of a monomeric acrylate or a methacrylate ester of a non-tertiary alcohol with a styrene macromer and additional optional monomers. Suitable macromers include styrene/acrylonitrile copolymer and polystyrene macromers. Examples of useful macromers and their preparation are described in detail in U.S. Pat. No. 4,693,776 (Krampe et al.).

When the core 102 includes a styrenic material, the (e.g., pressure-sensitive) adhesive contains 40 wt. % to 60 wt. % of one or more styrenic copolymers, based on the total weight of the adhesive, plus one or more tackifiers (and optionally additives). If the amount of the styrenic material is too low, the tackifier level may be too high and the resulting T_{g} of the composition may be too high for successful adhesion, particularly in the absence of a plasticizer. If the amount of the styrenic material is too high, however, the composition may have a modulus that is too high (e.g., the composition may be too stiff and/or too elastic) and the composition may not wet out well when the core-sheath filament adhesive 100 is melted, mixed, and applied to a substrate. The amount of the styrenic material can be at least 45 weight percent or at least 50 weight percent and up to 55 weight percent or up to 50 weight percent. In some embodiments, the amount of the styrenic material is in a range of 40 to 60 weight percent, 40 to 55 weight percent, 40 to 50 weight percent, 45 to 60 weight percent, 45 to 55 weight percent, or 50 to 60 weight percent based on the total weight of the core 102.

When a styrenic material is incorporated in the core 102, a tackifier is typically used to impart tackiness to the adhesive. Examples of suitable tackifiers include rosins and their derivatives (e.g., rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of synthetic tackifiers include: phenolic resins, terpene phenolic resins, poly-t-butyl styrene, hydrogenated poly(alpha methyl styrene), acrylic resins, or combinations thereof.

Exemplary hydrogenated hydrocarbon tackifiers include C9 and C5 hydrogenated hydrocarbon tackifiers. Examples of C9 hydrogenated hydrocarbon tackifiers include those sold under the trade designation: REGALITE S-5100, REGALITE R-7100, REGALITE R-9100, REGALITE R-1125, REGALITE S-7125, REGALITE S-1100, REGALITE R-1090, REGALREZ 6108, REGALREZ 1085, REGALREZ 1094, REGALREZ 1126, REGALREZ 1139, and REGALREZ 3103, sold by Eastman Chemical Co., Middelburg, Netherlands; PICCOTAC and EASTOTAC sold by Eastman Chemical Co.; ARKON P-140, ARKON P-125, ARKON P-115, ARKON P-100, ARKON P-90, ARKON M-135, ARKON M-115, ARKON M-100, and ARKON M-90 sold by Arakawa Chemical Inc., Chicago, IL; and ESCOREZ 5000 series sold by Exxon Mobil Corp., Irving, TX.

In some embodiments, the core 102 comprises a linear, (meth)acrylic-based polymeric tackifier. As used herein, the term “(meth)acrylic-based polymeric tackifier” refers to a polymeric material that is formed from a first monomer composition wherein at least 80 weight percent, at least 90 weight percent, at least 95 weight percent, at least 98 weight percent, at least 99 weight percent, or 100 weight percent of the monomers have a (meth)acryloyl group of formula —(CO)—CR═CH₂, where R is hydrogen or methyl. The (meth)acrylic-based polymeric tackifier has a glass transition temperature equal to at least 50° C. In some embodiments, the glass transition temperature (T_{g}) is at least 75° C. or at least 100° C. The glass transition temperature can be measured using a technique such as Differential Scanning Calorimetry or Dynamic Mechanical Analysis.

Some particular (meth)acrylic-based polymeric tackifiers contain up to 100 weight percent methyl methacrylate monomeric units. Other particular (meth)acrylic-based polymeric tackifiers contain a mixture of isobornyl (meth)acrylate monomeric units and a polar monomeric unit such as (meth)acrylic acid monomeric units or N,N-dimethylacrylamide monomeric units. Some suitable (meth)acrylic-based polymeric tackifiers are commercially available under the trade designation ELVACITE (e.g., ELVACITE 2008C, E2013, E2043, and E4402) from Lucite International incorporated (Cordova, TN, USA).

Any suitable amount of one or more tackifiers may be used. In some embodiments, the total amount of tackifier may be present in the core 102 in an amount of 30 parts by weight or more, based on 100 parts by weight of total styrenic material. Optionally, the tackifier may be present in an amount of about 2 parts by weight to about 20 parts by weight, 3 parts by weight to about 15 parts by weight, or even 4 parts by weight to about 10 parts by weight, based on the weight of the acrylic block copolymer.

In certain embodiments, the rubber-based pressure sensitive adhesive further includes an end-block reinforcing resin, which preferentially segregates to the glassy styrenic domains. End block tackifiers often have high glass transition temperatures, and help maintain the PSA's cohesive strength at elevated temperatures. The reinforcing end-block resin may be an aromatic, or partially aromatic. Useful resins include low molecular weight oligomers and polymers of styrene, α-methylstyrene, p-methylstyrene, coumarone indene, polyphenylene ether, and copolymers thereof. Examples endblock tackifiers include, but are not limited to, those available under the trade designations CUMAR (e.g., CUMAR 130 and 157) and NEVCHEM (e.g., NEVCHEM 240) from Neville Chemical Company (Pittsburgh, PA, USA), under the trade designations FTR2120 and FTR2140 from Mitsui Chemicals America, Inc. (Rye Brook, NY, USA), under the trade designation NORSOLENE (e.g., NORSOLENE S155 and W-140) from Total Cray Valley (Exton, PA, USA), under the trade designations KRISTOLEX (e.g., KRISTALEX 5140 and 3100), and ENDEX (e.g., ENDEX 155) from Eastman Chemical Company (Kingsport, TN, USA), under the trade designation H-REZ (H-REZ AMS-120 and AMS-140) from NUROZ LLC Miami, FL, USA), under the trade designation NORYL (e.g., NORYL SA90 and SA120), under the trade designation YS RESIN (e.g., YS RESIN SX100) from Yasuhara Chemical Co., Ltd. (Hiroshima, Japan), and under the trade designation WESTCO (e.g., WESTCO Ci-120) from Western Reserve Chemical (Stow, OH, USA).

In some embodiments, the amount of end block tackifier can be usually in less amounts of up to 15 weight percent based on a total weight of the pressure-sensitive adhesive. For example, if present, the amount of the tackifier is often in a range of 3 to 15 weight percent or 5 to 10 weight percent based on a total weight of the pressure-sensitive adhesive. The amount of the optional tackifier is often in a range of 0 to 20 weight percent, in a range of 0 to 10 weight percent, in a range of 0 to 8 weight percent, in a range of 0 to 6 weight percent, in a range of 1 to 10 weight percent, in a range of 1 to 8 weight percent, in a range of 1 to 6 weight percent, in a range of 2 to 10 weight percent, or in a range of 3 to 10 weight percent based on the total weight of the pressure-sensitive adhesive. In some embodiments, the pressure-sensitive adhesive composition is free or substantially free of this tackifier that is compatible with the glassy blocks of the styrenic block copolymer.

In certain embodiments, the core 102 comprises one or more (meth)acrylic-based adhesive polymers. (Meth)acrylic-based polymers have been described, for example, in the following patent references: EP Patent Application 2072594 A1 (Kondou et al.), U.S. Pat. No. 5,648,425 (Everaerts et al.), U.S. Pat. No. 6,777,079 B2 (Zhou et al.), and U.S. Patent Application Publication 2011/04486 A1 (Ma et al.).

In some embodiments, the (meth)acrylic polymer comprises the reaction product of a polymerizable composition comprising a chain transfer agent, a polar monomer, and at least one alkyl (meth)acrylate. Suitable representative chain transfer agents, polar monomers, and alkyl (meth)acrylate monomers are each described in detail below.

Examples of suitable alkyl (meth)acrylate monomers incorporated into (meth)acrylic polymers include, but are not limited to, methyl methacrylate, ethyl methacrylate, propyl methacrylate, n-butyl methacrylate, sec-butyl methacrylate, isobutyl methacrylate, tert-butyl methacrylate, n-hexyl methacrylate, cyclohexyl methacrylate, 2-ethylhexyl (meth)acrylate, isooctyl acrylate, n-octyl methacrylate, and 3,3,5-trimethylcyclohexyl methacrylate, and isobornyl (meth)acrylate.

Examples of suitable non-acid functional polar monomers include, but are not limited to, 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

Examples of suitable acid functional polar monomers include, but are not limited to, monomers where the acid functional group may be an acid per se, such as a carboxylic acid, or a portion may be salt thereof, such as an alkali metal carboxylate. Useful acid functional polar monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, carboxyethyl (meth)acrylate, 2-sulfoethyl methacrylate, styrene sulfonic acid, 2-acrylamido-2-methylpropanesulfonic acid, vinylphosphonic acid, and mixtures thereof. Due to their availability, acid functional polar monomers are generally selected from ethylenically unsaturated carboxylic acids, e.g., (meth)acrylic acids. When even stronger acids are desired, acidic polar monomers include the ethylenically unsaturated sulfonic acids and ethylenically unsaturated phosphonic acids may be used. The acid functional polar monomer is generally used in amounts of 1 to 15 parts by weight, preferably 1 to 10 parts by weight, based on 100 parts by weight total monomer.

A suitable monomer mixture may comprise: 50-99 parts by weight of alkyl (meth)acrylate monomers; and 1-50 parts by weight of polar monomers, (inclusive of acid-functional polar monomers); wherein the sum of the monomers is 100 parts by weight.

The polymerizable composition may optionally further comprise chain transfer agents to control the molecular weight of the resultant (meth)acrylate polymer. Examples of useful chain transfer agents include but are not limited to those selected from the group consisting of carbon tetrabromide, alcohols, mercaptans, and mixtures thereof. When present, the preferred chain transfer agents are isooctyl mercaptoacetate (e.g., commercially available from Evans Chemetics LP (Teaneck, NJ)) and carbon tetrabromide. The polymerizable composition to form a (meth)acrylic polymer may further comprise up to about 0.5 parts by weight of a chain transfer agent, typically about 0.01 to about 0.5 parts by weight, if used, preferably about 0.05 parts by weight to about 0.2 parts by weight, based upon 100 parts by weight of the total monomer mixture.

In certain embodiments a (meth)acrylic block copolymer may be used. Suitable (meth)acrylic block copolymers may have a block structure such as a di-block ((A-B) structure), a tri-block ((A-B-A) structure), a multi-block (-(A-B)n- structure), or a star block structure ((A-B)n- structure). Di-block, tri-block, and multi-block structures may also be classified as linear block copolymers. Star block copolymers fall into a general class of block copolymer structures having a branched structure. Star block copolymers are also referred to as radial or palm tree copolymers, as they have a central point from which branches extend. Block copolymers herein are to be distinguished from comb-type polymer structure and other branched copolymers. These other branched structures do not have a central point from which branches extend. The (meth)acrylic block copolymers can include any of the (meth)acrylic monomers described above. The (meth)acrylic block copolymer may comprise additional monomer units, for example, vinyl group monomers having carboxyl groups such as, e.g., (meth)acrylic acid, crotonic acid, maleic acid, maleic acid anhydride, fumaric acid, or (meth)acryl amide; aromatic vinyl group monomers such as, e.g., styrene, α-methyl styrene, or p-methyl styrene; conjugated diene group monomers such as, e.g., butadiene or isoprene; olefin group monomers such as, e.g., ethylene, or propylene; or lactone group monomers such as, e.g., ε-caprolactone or valero lactone; and combinations thereof. Example of (meth)acrylic block copolymer are available under the tradenames: Kurarity (available from Kuraray Chemical Corporation, Tokyo, Japan) and Nanostrength (available from Arkema, Colombes, France).

Methods of preparing the (meth)acrylic polymers for use in the core are not particularly limited; the (meth)acrylic polymer can be formed from the above-described polymerizable compositions by solution polymerization, emulsion polymerization, suspension polymerization, or bulk polymerization, as known to the skilled practitioner, for instance using typical polymerization initiation methods of ultraviolet radiation initiation and/or thermal initiation.

Poly(alpha-olefin) polymers, also referred to as poly(1-alkene) polymers, generally comprise an uncrosslinked polymer, which may have radiation activatable functional groups grafted thereon as described in U.S. Pat. No. 5,209,971 (Babu et al.). The polymer is tacky and predominantly amorphous. Useful poly(alpha-olefin) polymers include, for example, C₃-C₁₈ poly(1-alkene) homopolymers and copolymers of propylene with C₅-C₁₂ 1-alkenes, such as C₅-C₁₂ poly(1-alkene) polymers and copolymers of propylene with C₆-C₈ 1-alkenes.

Examples of poly(alpha-olefins) are available under the trade designations: Rexene (from Rextac LLC, Oddessa, Texas); Eastoflex (from Eastman Chemical Corp, Kingsport, Tennessee); and Vestoplast (Evonik, Essen, Germany).

Polyurethane is a generic term used to describe polymers prepared by the reaction of a polyfunctional isocyanate with a polyfunctional alcohol to form urethane linkages. The term “polyurethane” has also been used more generically to refer to the reaction products of polyisocyanates with any polyactive hydrogen compound including polyfunctional alcohols, amines, and mercaptans. The polyisocyanates may be linear or branched, aliphatic, cycloaliphatic, heterocyclic or aromatic or a combination thereof.

Silicone polymers include, for instance, a linear material described by the following formula illustrating a siloxane backbone with aliphatic and/or aromatic substituents:

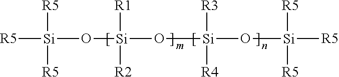

wherein R1, R2, R3, and R4 are independently selected from the group consisting of an alkyl group and an aryl group, each R5 is an alkyl group and n and m are integers, and at least one of m or n is not zero. In some embodiments, at least one of the alkyl or aryl groups may contain a halogen substituent (e.g., fluorine, for instance at least one of the alkyl groups may be —CH₂CH₂C₄F₉). In some embodiments, R5 is a methyl group (i.e., the nonfunctionalized silicone polymer is terminated by trimethylsiloxy groups). In some embodiments, R1 and R2 are alkyl groups and n is zero (i.e., the material is a poly(dialkylsiloxane)). In some embodiments, the alkyl group is a methyl group (i.e., poly(dimethylsiloxane) (“PDMS”)). In some embodiments, R1 is an alkyl group, R2 is an aryl group, and n is zero (i.e., the material is a poly(alkylarylsiloxane)). In some embodiments, R1 is methyl group and R2 is a phenyl group (i.e., the polymer is poly(methylphenylsiloxane)). In some embodiments, R1 and R2 are alkyl groups and R3 and R4 are aryl groups (i.e., the polymer is a poly(dialkyldiarylsiloxane)). In some embodiments, R1 and R2 are methyl groups, and R3 and R4 are phenyl groups (i.e., the polymer is poly(dimethyldiphenylsiloxane) or poly(methylphenylsiloxane)). In some embodiments, the nonfunctionalized silicone polymers may be branched. For example, at least one of the R1, R2, R3, and/or R4 groups may be a linear or branched siloxane with alkyl or aryl (including halogenated alkyl or aryl) substituents and terminal R5 groups. As used herein, “nonfunctional groups” are either alkyl or aryl groups consisting of carbon, hydrogen, and in some embodiments, halogen (e.g., fluorine) atoms. As used herein, a “nonfunctionalized silicone material” is one in which the R1, R2, R3, R4, and R5 groups are nonfunctional groups.

In many embodiments, to achieve the goals of providing structural integrity and a non-tacky surface, the sheath 104 comprises a material selected from a styrenic block copolymer, a polyolefin, ethylene vinyl acetate, a polyurethane, a styrene butadiene copolymer, either alone or in combination of any two or more. In certain embodiments, the sheath 104 comprises any one of these listed materials as the main component (e.g., the sheath 104 may also include one or more additives). Example suitable styrenic block copolymers and styrene butadiene copolymers are as described in detail above with respect to the core 102.

Suitable polyolefins are not particularly limited. Suitable polyolefin resins include for example and without limitation, polypropylene (e.g., a polypropylene homopolymer, a polypropylene copolymer, and/or blends comprising polypropylene), polyethylene (e.g., a polyethylene homopolymer, a polyethylene copolymer, high density polyethylene (HDPE), medium density polyethylene (MDPE), low density polyethylene (LDPE)), and combinations thereof. For instance, suitable commercially available LDPE resins include PETROTHENE NA217000 available from LyondellBasell (Rotterdam, Netherlands) and MARLEX 1122 available from Chevron Phillips (The Woodlands, TX).

Suitable ethylene vinyl acetate (EVA) polymers (i.e., copolymers of ethylene with vinyl acetate) for use in the sheath 104 include resins from DuPont (Wilmington, DE) available under the trade designation ELVAX. Typical grades range in vinyl acetate content from 9 to 40 weight percent and a melt flow index of as low as 0.03 grams per minute. (per ASTM D1238). Suitable EVAs also include high vinyl acetate ethylene copolymers from LyondellBasell (Houston, TX) available under the trade designation ULTRATHENE. Typical grades range in vinyl acetate content from 12 to 18 weight percent. Suitable EVAs also include EVA copolymers from Celanese Corporation (Dallas, TX) available under the trade designation ATEVA. Typical grades range in vinyl acetate content from 2 to 26 weight percent.

Core-sheath filament adhesives 100 described herein, in some instances, further comprise one or more additives, such as one or more additives selected from the group consisting of a filler, a plasticizer, an antioxidant, a pigment, a hindered amine light stabilizer, an ultraviolet light absorber, or combinations thereof. Typically, one or more additives are provided in the core 102 due to its larger volume than the sheath 104, although in certain embodiments additive(s) can be included in the sheath 104 of the core-sheath filament adhesive 100.

In some embodiments, the core-sheath filament adhesive 100 can include an optional plasticizer, but most typically with the midblock. The plasticizer is often selected to be compatible with one or more blocks of a styrenic block copolymer, but most typically with the midblock. As with the tackifiers, compatibility between the plasticizer and one of the blocks is indicated by a change (e.g., a decrease) in the glass transition temperature of the block. In some embodiments, the plasticizer is selected from a naphthenic oil, a liquid (at room temperature) polybutene resin, a liquid (at room temperature) polyisobutylene resin, a liquid (at room temperature) paraffin, a liquid (at room temperature) isoprene or butadiene polymer, or a phosphate ester.

Example napththenic oil plasticizers that can be added include, but are not limited to, those commercially available under the trade designation NYFLEX (e.g., NYFLEX 222B) from Nynas Naphthenics AB (Stockholm, Sweden) and under the trade designation CALSOL (e.g., CALSOL 5550) from Calumet Specialty Products Partners (Indianapolis, IN, USA). Example liquid paraffin plasticizers that can be added include, but are not limited to, those commercially available under the trade designation FLEXON (e.g., FLEXON 845) from Exxon (Irving, TX, USA), under the trade designation KAYDOL from Paraffinic Sonneborn (Parsippany, NJ, USA), under the trade designation SUNPAR (e.g., SUNPAR 150) from Sunoco (Dallas, TX, USA), and under the trade designation TUFFLO (e.g., TUFFLO 6056) from CITGO (Houston, TX, USA). Example liquid polybutene plasticizers include, but are not limited to, those commercially available under the trade designation OPPANOL (e.g., OPPANOL B12 SNF) from BASF (Florham Park, NJ, USA) and under the trade designation INDOPOL (e.g., INDOPOL H-8) from Ineos Oligomers Products (League City, TX, USA). Example phosphate esters include, but are not limited to, those commercially available under the trade designation SANTICIZER (e.g., SANTICIZER 141) from Valtris Specialty Chemicals (Independence, OH, USA).

A core-sheath filament adhesive 100 described herein optionally also comprises one or more hindered amine light stabilizers, ultraviolet light absorbers, or combinations thereof. For instance, antioxidants may be chosen to improve the high temperature stability of the rubber-based adhesive formulation, such as those taught in U.S. Provisional Patent Application No. 63/393,495, titled “Stabilized Hot Melt Pressure-Sensitive Adhesives.” Also, if used, a stabilizing agent is present in an amount of about 0.1-5% by weight, about 0.5-4% by weight, or about 1-3% by weight, or about 0.1 to 0.5% based on the total weight of the core-sheath filament adhesive 100.

A core-sheath filament adhesive 100 as described herein can also comprise one or more ultraviolet light absorbers (e.g., dyes, optical brighteners, pigments, particulate fillers, etc.), such as TINOPAL OB, a benzoxazole, 2,2′-(2,5-thiophenediyl)bis[5-(1,1-dimethylethyl)], available from BASF Corporation, Florham Park, NJ. The ultraviolet light absorber, if used, can be present in an amount of about 0.001-5% by weight, about 0.01-1% by weight, about 0.1-3% by weight, or about 0.1-1% by weight, based on the total weight of the core-sheath filament adhesive 100.

Core-sheath filaments adhesives 100 may include fillers, such as glass bubbles, expandable microspheres, silica, carbon, calcium carbonate, clay, talc, titanium dioxide, surface-treated silica, conductive particles, graphite, resin particles, kaolin, glass fibers, or combinations thereof. Examples of suitable fillers are naturally occurring or synthetic materials including, but not limited to: silica (SiO₂ (e.g., quartz)); alumina (Al₂O₃), zirconia, nitrides (e.g., silicon nitride); glasses and fillers derived from, for example, Zr, Sr, Ce, Sb, Sn, Ba, Zn, and Al; feldspar; borosilicate glass; kaolin (china clay); talc; zirconia; titania; and submicron silica particles (e.g., pyrogenic silicas such as those available under the trade designations AEROSIL, including “OX 50,” “130,” “150” and “200” silicas from Degussa Corp., Akron, OH and CAB-O-SIL M5 and TS-720 silica from Cabot Corp., Tuscola, IL).

Organic fillers made from polymeric materials are also possible, such as those disclosed in International Publication No. WO09/045752 (Kalgutkar et al.).

The core-sheath filament adhesive 100 may additionally contain colorants such as dyes, pigments, and pigment dyes. Examples of suitable colorants as described in U.S. Pat. No. 5,981,621 (Clark et al.) include 1-hydroxy-4-[4-methylphenylamino]-9,10-anthracenedione (FD&C violet No. 2); disodium salt of 6-hydroxy-5-[(4-sulfophenyl)oxo]-2-naphthalenesulfonic acid (FD&C Yellow No. 6); 9-(o-carboxyphenyl)-6-hydroxy-2,4,5,7-tetraiodo-3H-xanthen-3-one, disodium salt, monohydrate (FD&C Red No. 3); and the like.

Examples of useful pigments include, without limitation: white pigments, such as titanium oxide, zinc phosphate, zinc sulfide, zinc oxide and lithopone; red and red-orange pigments, such as iron oxide (maroon, red, light red), iron/chrome oxide, cadmium sulfoselenide and cadmium mercury (maroon, red, orange); ultramarine (blue, pink and violet), chrome-tin (pink) manganese (violet), cobalt (violet); orange, yellow and buff pigments such as barium titanate, cadmium sulfide (yellow), chrome (orange, yellow), molybdate (orange), zinc chromate (yellow), nickel titanate (yellow), iron oxide (yellow), nickel tungsten titanium, zinc ferrite and chrome titanate; brown pigments such as iron oxide (buff, brown), manganese/antimony/titanium oxide, manganese titanate, natural siennas (umbers), titanium tungsten manganese; blue-green pigments, such as chrome aluminate (blue), chrome cobalt-alumina (turquoise), iron blue (blue), manganese (blue), chrome and chrome oxide (green) and titanium green; as well as black pigments, such as iron oxide black and carbon black. Combinations of pigments are generally used to achieve the desired color tone in the core-sheath filament adhesive 100. The use of florescent dyes and pigments can also be beneficial in enabling the composition to be viewed under black-light. A particularly useful hydrocarbon soluble fluorescing dye is 2,5-bis(5-tert-butyl-2-benzoxazolyl) 1 thiophene. Fluorescing dyes, such as rhodamine, may also be bound to cationic polymers and incorporated as part of the filament.

In certain embodiments, colorant(s) are included in the core 102 to impart a certain color (e.g., yellow) and colorant(s) are included in the core 102 to impart a certain different color (e.g., blue), such that a color (e.g., green) of an adhesive can be observed to readily demonstrate effective mixing of the core 102 and sheath 104 materials. In select embodiments, colorant(s) can be included in the core 102 and/or sheath 104 portions of the filament to provide color matching of an adhesive with a substrate on which it is or with another material included in an end use, such that the presence of the adhesive is less visibly noticeable after printing than if the core-sheath filament adhesive 100 did not contain the colorant(s).

Combinations of any of the above additives may also be employed. The selection and amount of any one such additive can be selected by one of skill in the art to accomplish the desired result without undue experimentation.

### Manufacturing Equipment and Methods

FIGS. 2A-2C are convenient for schematically illustrating exemplary methods and equipment for injection molding filament adhesive of the present invention. FIG. 2A illustrates the different portions expanded from one another. FIGS. 2B and 2C illustrate the nozzle 31 in fluid communication with the injection mold 12. FIG. 2C illustrates the portions of the mold 12 in the closed position.

System 10 includes a spool 236 for supplying core-sheath filament adhesive 100 described above. It is convenient for when injection molding of the filament adhesive 100 if wherein the filament adhesive 100 is loaded onto a low friction shaft, and an additional motorized feed mechanism (e.g. gripping wheel or powered nip) is used to pull the filament adhesive 100 off the spool 236 and deliver into the injection molding inlet, as needed. Optionally, a tension sensor (e.g., dancer) can be included to provide closed loop feedback on filament adhesive tension for further improvement in feed control. Also optionally, the feed mechanism circumferential speed may be controlled as a ratio to the tangential speed of the injection molding screw via a feedback loop.

The filament adhesive 100 is feed through a feed throat 250 and into a barrel 30 and screw 32. The barrel and screw 30, 32 are used to masticate, plasticize, heat and mix the portions of the filament adhesive before delivering a molten composition 238 through the outlet in the nozzle 31. The screw 32 is powered by a hydraulic (or electric) motor and pump 26.

The system 10 includes the injection mold 12. The injection mold 12 includes a stationary portion 14, often referred to as “A-side”, illustrated in its stationary molding portion in FIGS. 2B and 2C and includes a moving portion 16 (“B-side”), illustrated in FIGS. 2B and 2C. The stationary portion 14 of the mold 12 is mounted to the stationary platen 18. The moving portion 16 of the mold 12 is mounted to the moving platen 20 and is allowed to move transversely along the tie bar 22. The injection molding machine 10 also includes a clamping unit 24, which is used to clamp the first portion 14 of the mold 12, which is stationary in position, to the second portion 16 of the mold 12 after it has moved into position adjacent the first portion 14, as illustrated in FIG. 2C.

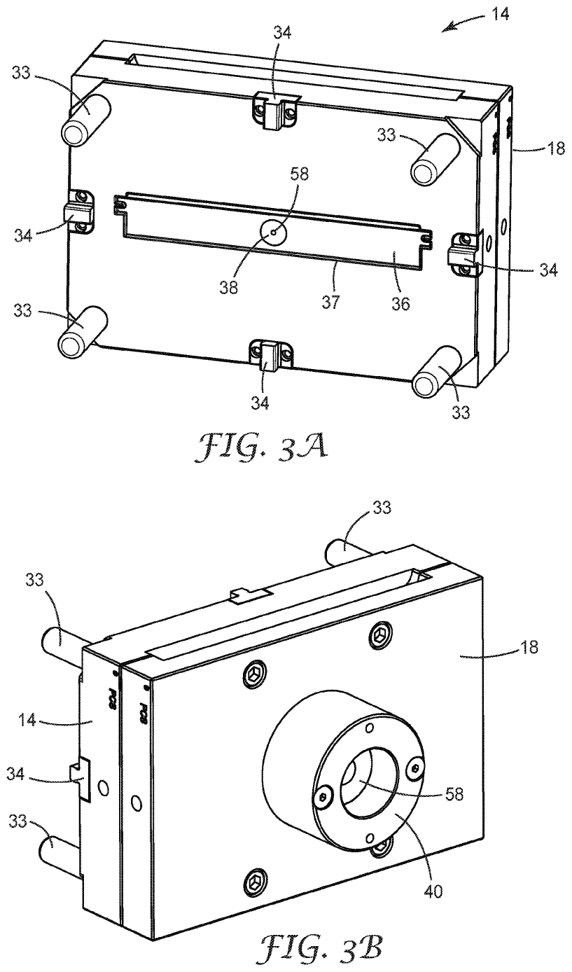

FIGS. 3A and 3B are convenient for describing the stationary portion 14 of the injection mold 12. The stationary portion 14 includes a top clamp platen 18 and a valve gate 40 extending therefrom. On the side opposite of the top clamp platen 18, the stationary portion 14 also includes leader pins 33 extending from the portion 14, which are designed to interact with the moving portion 16 of the mold 12. Positioned between the leader pins 33 and adjacent the outward sides of the portion 14, the portion 14 includes side locks 34. Although the stationary portion 14 is illustrated with four leader pins 33 and four side locks 34, any number of leader pins and side locks may be used. The stationary portion 14 of the injection mold 12 includes a desired mold cavity 36, which is shaped to receive the molten composition through the valve gate 40 and the valve gate inlet 38 and through the heated flow channel 58, all of which are included in the hot runner system. Then, mold the molten composition 238 of the filament adhesive 100 in the shape of the combined cavities 36, 42. The mold cavity 36 includes a perimeter 37 specially designed for molding the adhesive composition 238.

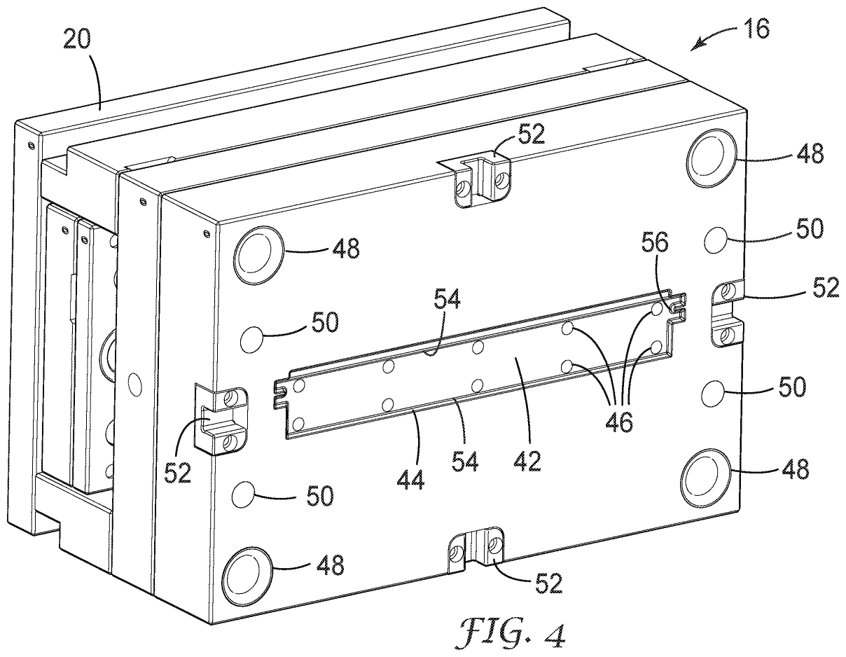

The moving portion 16 of the injection mold 12 is illustrated in FIG. 4. The moving portion 16 includes leader pin bushings 48 designed to engage with the leader pins 33 in the stationary portion 14 in the mold closed position. The moving portion 16 also includes side locks 52 located between the leader pin bushings 48 designed to engage with the side locks 34 in the stationary portion 14 in the mold closed position. The moving portion 16 of the mold 12 includes a desired mold cavity 42, which is shaped to receive the molten composition through the valve gate 40 and the vale gate inlet 38, and then mold the molten composition 238 of the filament adhesive 100 in the shape of the combined cavities 36, 42. The mold cavity 42 includes a specially designed perimeter 44. The cavity 42 in the moving portion 16 may be designed to hold a substrate 80 (not shown) or alternatively a base liner 94 (not shown). The substrate 80 or the base liner 94 may be held in position within the cavity 42 by static pins or vacuum source (not shown) or by other means in the art. The mold portion 16 may include an array of ejector pins 46 arranged with the cavity 42 to assist in ejecting the substrate 80 or base liner 94 from the mold 12 upon completion of the injection molding process.

The perimeter 37 in the mold cavity 36 in the stationary portion 14 and the perimeter 44 in the mold cavity 37 in the moving portion may include specially designed features. Because the base liner 94 or substrate 80 is thermoformed against the mold cavity 42, it is especially important to consider the geometry of the mold cavity's side walls and edges. Chamfering the side walls 56 or adding a fillet to any inside corner or a radius 54 to any outside corner, will help prevent the liner 94 or substrate 80 from tearing. Chamfer angles of 10 degrees to 70 degrees are preferred, with the most preferred angle being 45 degrees. Minimal fillet or radius measurements of 0.5 mm to 1.5 mm are preferred to break sharp edges. As the depth of the mold cavity decreases, the need for rounded corners (radiuses) 54 or chamfers may be reduced.

Due to the properties of the pressure sensitive adhesive, the system 10 preferably includes a heated runner or entry into the mold 12, otherwise it will tend to adhere to the material delivery system 250, 30, 32,31, and to the mold 12 after cooling and solidifying. Using a standard cold-runner and typical gate designs, like a tunnel gate, would prevent smooth ejection of the substrate 50 (part, sprue, and runner, etc.). Also, direct gating, where the “gate” is formed by the sprue bushing, would cause ejection problems, as the (cold) pressure sensitive-sprue would most likely stick to the sprue bushing. To ensure proper ejection, the pressure sensitive adhesive should not adhere to any part of the mold 12 or at least to a minimum as the adhesion forces would potentially either completely prevent ejection or harm the part being molded.

To solve the problem of the molten pressure sensitive adhesive 238 in the runner and gate adhering to the mold, a heated (or “hot-runner,” as it is sometimes referred to in the art) runner and gate is proposed. The hot-runner is part of a hot-runner-system which is defined herein including the claims as a series of heated components, typically electric, but can be liquid heated, which are used to convey molten material in an injection mold. In some cases, multiple injection nozzles can deliver material to one or more mold cavities 36, 42. The main feature of a hot runner is described as the flow path between the nozzle of the injection unit and the gate(s) to the substrate 80, base liner 94, part etc. are in a “hot stage” (usually in the range of the nozzle temperature). Typically, a hot-runner-system consists of a heated bushing, a heated manifold including the runner, a heated flow channel and the heated nozzle(s) including the valve gates. The hot runner system is usually thermally isolated from the surrounding material of the mold to enable different temperatures for the flow channel and cavity. In a preferred embodiment, the flow channel in the hot runner system is heated to be above the melting point of the filament adhesive. The rest of the mold is at a lower temperature enable the solidification of the molten filament adhesive material by cooling it down. Using a hot runner system will enable smooth ejection of the substrate 80, base liner 94, part etc. as from the mold 12 typically only the pressure sensitive adhesive of the part will cool down and solidify. As described above, there will be no cold pressure sensitive adhesive sticking to areas of the mold 12, which will enable easy part ejection from the mold 12.

In order to increase the efficiency and reduce cost for higher volume parts, it may be advantageous to use multishot-molding technology, comprising e.g. multiple injection units and/or a multi-cavity mold (not shown); in this case, a machine with multiple injection units is used, where at least one of the units processes the pressure sensitive adhesive. Using multi-shot molding enables the molding of the substrate 80 or part in a first shot and pressure sensitive adhesive domain in a second shot in a direct sequence on one injection molding machine. There are several known techniques for designing a multi-shot process and mold, e.g. “core back”, “part transfer” or rotating mold. One advantage of this approach is that it can make uses of existing multi-cavity injection molding machines that are already commercially available. Also, the pressure sensitive adhesive may bond better to the plastic part or substrate 80, since there is reduced opportunity for surface contamination and the thermoplastic part 80 (first shot) is still in a warm stage, which will support adhesion build-up of the molten adhesive composition 238 (second shot).

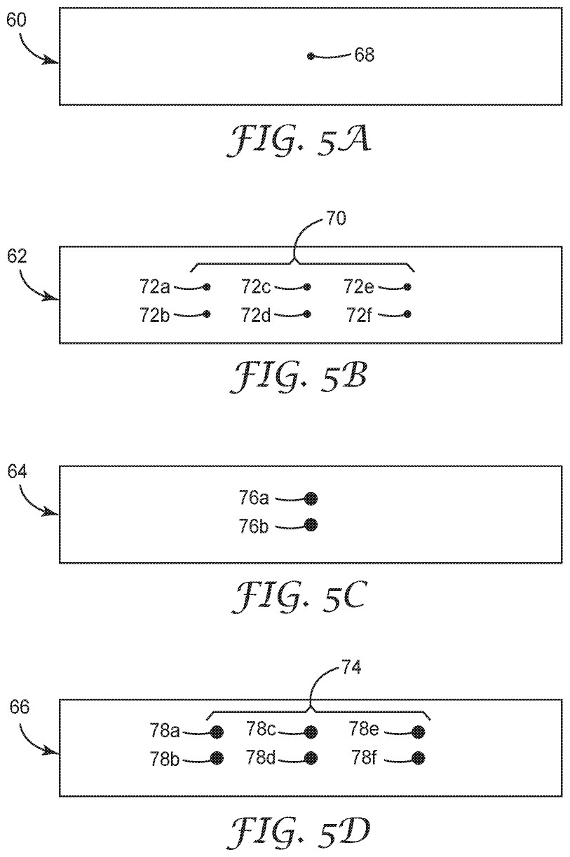

FIGS. 5A-5D are top view of various embodiments of release liners, which are useful in the manufacturing equipment and methods described here. Specifically, the release liners 60, 62, 64, 66 are designed to fit within the cavity 36 in the stationary portion 14 of the mold 12. Each release liner includes at least one hole therethrough specifically designed to allow the molten adhesive composition 238 to flow through and into the rest of the combined cavity 36, 42. This configuration allows the surface of the molded adhesive to not have any inherent or visible marks where the flow channel or valve gate 38 was located. Ideally, the flow channel 58 and the valve gate 38 leading into the flow channel 58 would be recessed into the mold cavity 36. This is important because when injecting through the liner (e.g., through one or more holes in the liner), the adhesive surface should not protrude in a way that would interfere with wetting out the pressure sensitive adhesive when mating against another substrate in the final assembled product. That is, the flow channel 58 should be recessed into the part, or a pressure sensitive adhesive with sufficiently low durometer should be used to allow for any protrusion to be deformed when forming the final bond.

FIG. 5A illustrates one embodiment of a release liner 60 having a centered hole 68. FIG. 5B illustrates another embodiment of a release liner 62 having an array 70 of holes 72. This array includes six holes 72a-72f arranged in a rectangular layout to match the rectangular shape of the overall liner 62. FIG. 5C illustrates another embodiment of a release liner 64, which includes two centered holes 76a, 76b. The holes 76a, 76b are larger compared to the holes 68, 72. Lastly, FIG. 5D illustrates another embodiment of release liner 66 including an array 74 of holes 78. Like release liner 62, this array includes six holes 78a-78f arranged in a rectangular layout to match the rectangular shape of the overall liner 66, except that the diameter of the holes 78 are bigger than the diameter of the holes 72. Depending on the desired amount of molten adhesive 238 flowing into the mold cavities 36, 42, the size, number and shape of the holes may be optimized in the release liner. The holes may be laser cut or by other means know in the art.

There are advantages in using certain liners inside the mold 12. For certain embodiments, using silicone coated release liners into the mold 12 and injecting between a part and liner prevents the molten pressure sensitive composition 238 from sticking to the cavities 36, 42 in the mold. Also, once the injection molding process is complete, the final substrate does not have exposed PSA because of the release liner being on the layer of molded adhesive 90, and therefore the parts will not adhere to each other during storage and transportation. It is important to have an appropriate degree of release force. If the release force is too low, then the release liner will fall off or partially de-wet; and if it is too high, then it will be difficult to remove the release liner from the molded adhesive layer 90. It is desirable that edges of the liner overhang the part, to provide a convenient place to grip the liner in order to remove it, when desired. Silicone chemistries offer a good range of release chemistries, when considering the molten hot melt pressure sensitive adhesives will directly contact the liner. Various silicone chemistries are known. These include UV cure, platinum cure, 2-part, and solvent coated silicone chemistries. The liner film can be treated prior to silicone coating (e.g., corona or flame treatment, or chemical priming). It is understood that the silicone chemistry and base film should be selected to not transfer to the pressure sensitive adhesive and should withstand the heat and deformation associated with the injection molding process. Release liner film materials especially suited for thermoforming are polyester (e.g., PET) or polypropylene. In any case, the temperature and other injection molding conditions need to be optimized to avoid melting or tearing the liner. The exact mold cavities 36, 42 geometries may allow for other liners to be used. For example, if no thermoforming of the liner happens, it may be feasible to use non-extensible liners, such as SCK (silicone coated kraft) liners.

Introduction of release liners into an injection molding process can be done using existing machines designed for in-mold labeling (or in-mold decoration). Instead of the label film, a release liner is used. Automated winding/unwinding systems to advance the liner into the mold may also be used.

In alternative methods, instead of injecting the molten adhesive composition through a hole in the liner, the injection side could be located on base liner 94 or substrate 80 or edge of bond line to avoid visual defects in the show surface of the part.

In yet another alternative method, instead of injection molding through a hole in a liner, the method may include injection molding the filament adhesive composition through a hole in a substrate, which may be in any form except that of a release liner.

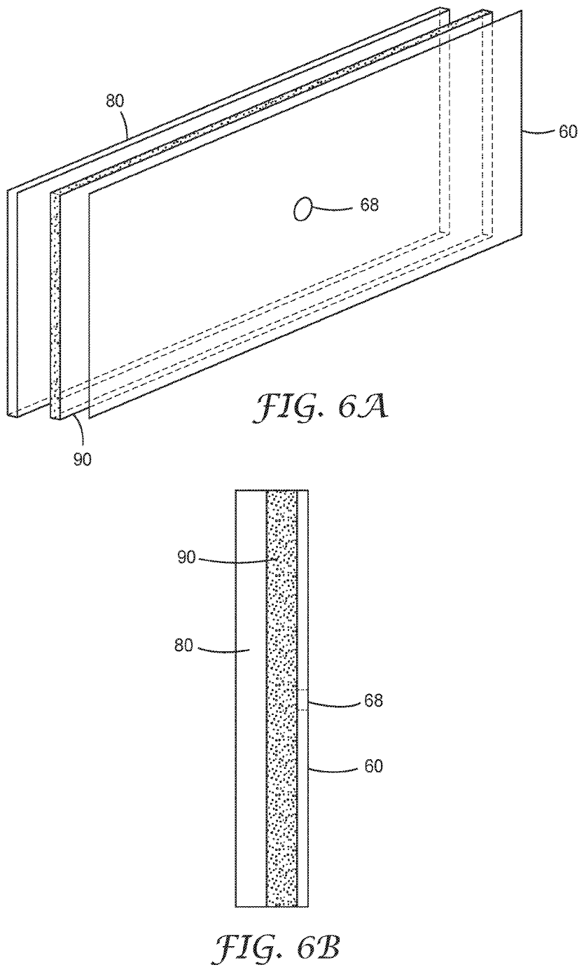

FIGS. 6A and 6B illustrate one embodiment where the filament adhesive 100 is injected molded onto a substrate 80 using release liner 60 having a centered hole 68. The molded adhesive 90 will form into whatever shape is inside cavity 36 on the major surface of the substrate 80. FIG. 6A illustrates an exploded view, whereas FIG. 6B illustrates a cross sectional view of this embodiment. The substrate 80 may be any part or subassembly desired, and the cavity 42 will be sized to hold the substrate 80 during the injection molding process.

In one embodiment, the substrate 80 is made prior to the injection molding process and simply inserted into the mold 12. However, in another embodiment, the substrate 80 itself could be made of a material that is first injection molded into the mold 12 and solidified, before the adhesive is then injected molded onto the major surface of the substrate 80. In this case, a different stationary mold 14 would be used for injection molding the substrate 80.

Although one type of filament adhesive is used as described above, it is possible to have multiple filament adhesives of differing types used in the manufacturing processes and equipment described herein, which would then allow one skilled in the art to create a workpiece that combines different injected molded adhesives.

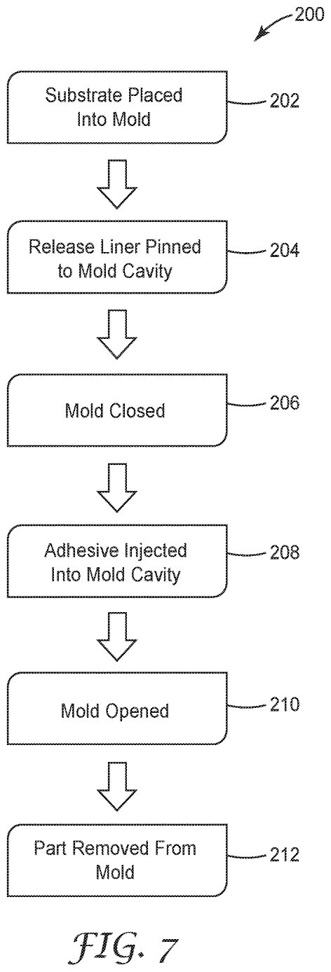

FIG. 7 provides a flow chart to generally provide the different steps in one embodiment of the method 200 of the present invention. The first step 202 includes placing a substrate or part 80 into the mold cavity 42 in the moving portion 16 of the mold 12 of the system 10, discussed in detail above. The second step 204 is to place a release liner 60 into the mold cavity 36 of the stationary portion 14 of the mold 12 of the system 10, discussed in detail above. In either step 202 or step 204, vacuum source(s) or static pinning may be used to hold the release liner 60 or substrate 80 or in their respective cavities 36, 42. The third step 206 includes closing the two portions 14, 16 of the mold 12 with the substrate 80 and release liner 60 in position. The fourth step 208 includes injecting and molding the molten adhesive 238 onto the major surface of the substrate 80. In one option as discussed above, the molten adhesive 238 is injected through at least one hole, as described above, to reduce surface imperfections or visual defects on the outer layer of adhesive adjacent the major surface of the liner. In another option as discussed above, the molten adhesive 238 is injected between the substate 80 and the release liner between their respective minor surfaces, as discussed above. In the fifth step 210, the mold 12 is opened, and in the sixth step 212 the substrate 80 with the layer of adhesive 90 molded on the major surface of the substrate 80 is removed from the mold 12, with the release liner 60 on top. Examples 1-6 includes specific examples and exemplary manufacturing parameters for this method 220.

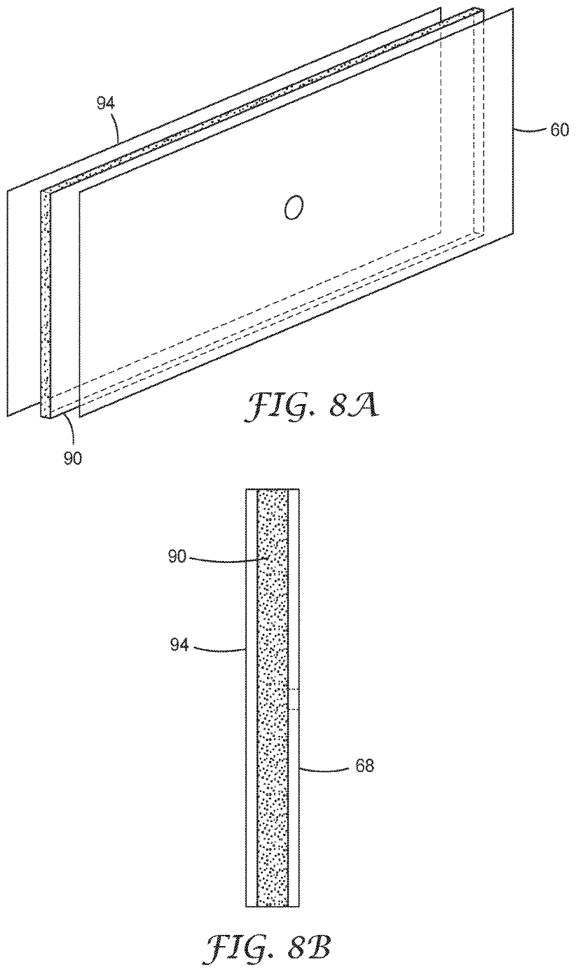

FIGS. 8A and 8B illustrate one embodiment where the filament adhesive 100 is injected molded onto a base liner 94 using release liner 60 having a centered hole 68. The molded adhesive 90 will form into whatever shape is inside cavity 36 on the major surface of the base liner 94. FIG. 8A illustrates an exploded view, whereas FIG. 8B illustrates a cross sectional view of this embodiment. The cavity 42 will be sized to hold the base liner 94 during the injection molding process.

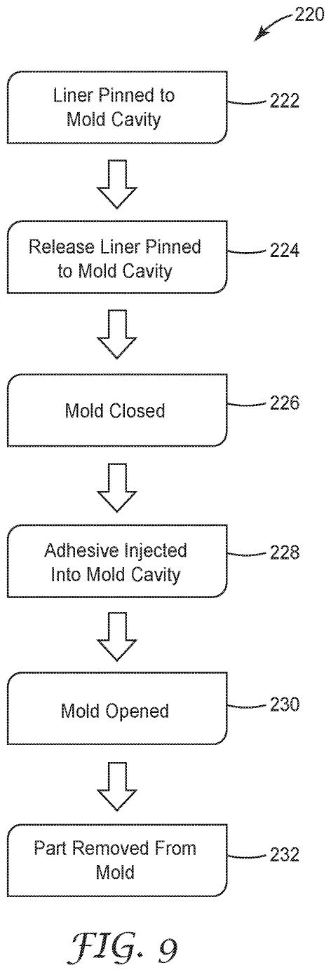

FIG. 9 provides a flow chart to generally provide the different steps in another embodiment of the method 220 of the present invention. The first step 222 includes placing a base liner 94 into the mold cavity 42 in the moving portion 16 of the mold 12 of the system 10, discussed in detail above. The second step 224 is to place a release liner 60 into the mold cavity 36 of the stationary portion 14 of the mold 12 of the system 10, discussed in detail above. In either step 222 or step 224, vacuum source(s) or static pinning may be used to hold the release liner 60 or base liner 94 or in their respective cavities 36, 42. The third step 226 includes closing the two portions 14, 16 of the mold 12 with the base liner 94 and release liner 60 in position. The fourth step 228 includes injecting and molding the molten adhesive 238 onto the major surface of the base liner 94. In one option as discussed above, the molten adhesive 238 is injected through at least one hole, as described above, to reduce surface imperfections or visual defects on the outer layer of adhesive adjacent the major surface of the liner. In another option as discussed above, the molten adhesive 238 is injected between the base liner 94 and the release liner between their respective minor surfaces, as discussed above. In the fifth step 230, the mold 12 is opened, and in the sixth step 232 the base liner 94 with the layer of adhesive 90 molded on the major surface of the base liner 94 is removed from the mold 12, with the release liner 60 on top. Example 7 includes specific examples and exemplary manufacturing parameters for this method 220.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight. The following abbreviations are used in this section: min=minute, s=second, Pa*s=Pascal*second, g=gram, kg=kilogram, pound=pound, mm=millimeter, um=micrometer, in =inch, centimeter=cm, ° C.=degrees Celsius, ° F.=degrees Fahrenheit, Hz=Hertz, rad=radian, in =inch, and PSI=pound per square inch.

TABLE 1
Materials List

| Designation | Description |
|---|---|
| VHB-XT | Filament adhesive, obtained under |
| | the trade designation “3M ™ VHB ™ |
| | Extrudable Tape”, from 3M Company, St. Paul, MN |
| Liner 1 | Polypropylene liner, 100 micrometers thick, |
| | on siliconized side, blue color, obtained under |
| | the trade designation “SILPROP CP1 100 M 4R13037 |
| | Blue”, from Siliconature Corporation, |
| | Caledonia, MI |
| Liner 2 | Liner, obtained under the trade |
| | designation “SILPHAN K 160 M 2R91010 |
| | Clear”, from Siliconature Corporation, Caledonia, MI |
| Liner 3 | Liner, obtained under the trade |
| | designation “2.5 CL PPF u1292/000”, |
| | from Loparex, Cary, NC |
| Substrate 1 | Acrylonitrile Butadiene Styrene, 12 in (305 mm) × |
| | 24 in (610 mm) × 1/16 in (16 |
| | mm) sheet, Part number 8586K351, obtained |
| | from McMaster-Carr, Aurora, OH |
| Substrate 2 | Nylon 6/6, 12 in (305 mm) × 24 in (610 mm) × 1/1 |
| | in (16 mm) sheet, Part number 8539K11, |
| | obtained from McMaster-Carr, Aurora, OH |

### Test Methods

### Shear Viscosity Measurements

Shear viscosity of the adhesives was measured using a rotational shear rheometer (Model ARES G2, available from TA Instruments, Waters, New Castle, DE) equipped with 25 mm parallel plate fixtures. Temperature was controlled using a nitrogen-purged forced convection oven. The oven was preheated to 200° C. and the gap between the plates was zeroed. Then, approximately 1 g of adhesive was melted on to the lower test plate. The plate gap was set to 1.05 mm, excess material was trimmed, and then the gap was set to 1 mm.

The sample was then subjected to rotational oscillatory shear deformations at multiple temperature steps and oscillatory frequencies. Temperature steps were set starting from 120° C. to 225° C. in 5° C. intervals. At each temperature step, the adhesive was subjected to oscillatory shear deformations at a strain amplitude of 1% and frequencies from 0.2 Hz to 20 Hz, sampled at 5 points per decade. Strain amplitude could change according to the rheometer's autostrain function, gradually increasing strain amplitude to improve measurement signal while maintaining strain within the viscoelastic range (less than 10%) and keeping overall instrument torque below 20 g-cm. The complex modulus (G*) was reported for each temperature and frequency pair.

The resulting data were then shifted using time-temperature superposition to predict the complex viscosity at a broader range of frequencies. First, a baseline vertical shift was applied to the modulus data, inversely proportional to the absolute temperature (Kelvin) of each step. The data at 190° C. were held fixed, and the remaining isothermal frequencies sweeps were shifted along the log frequency x-axis so that complex modulus (G*) superimposed into a “master curve.” Complex viscosity (η*) was then derived from the complex modulus, equal to G* divided by the shifted frequency. The Cox-Merz transformation was applied, by which complex viscosity (η*) as a function of angular frequency in rad/s was converted at a one-to-one equivalence to viscosity (q) as a function of shear rate in sec⁻¹. A set of shift factors a_{T} were generated from the distance each isotherm was shifted along the x-axis and could be used to reevaluate viscosity at different temperatures within the measured range. At 190° C., the value for VHB-XT was 772 Pa*s at 10 sec⁻¹, 256 Pa*s at 100 sec⁻¹, and 57.6 Pa*s at 1000 sec⁻¹.

### Green Strength Test Method

Green Strength was evaluated by dispensing adhesive at 205° C. The adhesive filament was processed through a Nordson Probond™ System, (Model 40 dispenser available from Nordson Corporation, Duluth, GA). The blended filament was dispensed between two anodized aluminum panels. The aluminum panels were 50 mm by 25.4 mm and each had a 6 mm diameter hole centered across the width and 2 mm from one end lengthwise. The aluminum panels were cut and punched from anodized aluminum sheets, 1.5 mm thick, (available from Lawrence and Frederick, Inc., Steamwood, IL). A 0.6 g quantity of blended filament was dispensed onto the first panel, and the second panel was immediately pressed down to a gap of 1 mm. The second panel was aligned such that the two panels had a 25 mm wide by 12.7 mm long overlap area substantially filled with adhesive. The second panel had the opposite lengthwise orientation such that the holes on each panel were overhanging on opposite ends along the length of the bonded sample. The adhered panels were hung by an “S” hook on a 6 mm diameter aluminum post held in fixed position horizontally, 50 mm off the ground. On the bottom or opposite end another “S” hook was placed in the whole in the panel and a 3 kg weight was hung from the adhered panels. The entire dispensing and set up process took less than 20 sec. Passing the Green Strength Test Method requires the panels to remain adhered and in position, with no bond failure within the first 2 minutes. VHB-XT passed the test; 3 kg holding when closing bond within 20 sec.

### Mold Description for Preparation of Molded Samples, Examples 1-7 (EX1-EX7)

A standard P20 steel mold base (Model number 812A-17-17-24, available from DME Company, Madison Heights, MI) with approximate outer dimensions of 300 mm by 200 mm by 244 mm was used. The mold base consisted of two halves (A and B-side halves), where injection occurred through the A-side half. The mold base had integrated thermal transfer fluid channels, one injection location, and ten 6 millimeters ejector pins. Each half of the mold was clamped to the injection molding machine platens using corresponding steel blocks with approximate dimension of 40 mm by 50 mm by 160 mm. The steel blocks fit into notches on the mold and were bolted to the platens to securely hold it in place. The A-side half had 4 leader pins that were 19 mm diameter and extended 34 mm from the outer surface of the mold half. The B-side half had corresponding bushings to receive the leader pins. The leader pins and bushings aligned the mold halves when it was closed and were standard based on the mold base size used. Further alignment was accomplished by the use of 4 side locks (Model number TL-125, available from Progressive Components Wauconda, IL) which were located on each side of the mold base.

The cavity was machined into the A and B-side halves of the mold base using a computer numerical controlled (CNC) vertical milling machine center (Model number VF3 available from Haas Automation, Oxnard, CA). On the B-side half, the cavity was approximately 25 mm by 200 mm by 1.6 mm. The ejector pins were aligned to be approximately evenly spaced along the longest dimension of the cavity. Additional features were machined into the mold cavity at 25.4 mm (1 in) intervals, which resulted in a design to mimic a measuring ruler. On the A-side half, the cavity was approximately 25 mm by 200 mm by 1.6 mm. The flow channel was centered on the A-side half cavity and the orifice size was 1.5 mm.

A manifold was used (Model number 5273177-10-1, available from Mold-Masters, Georgetown, Ontario, Canada) to control the material flow into the mold cavity. This design was runner-less, and the flow channel was in direct contact with the mold cavity. This eliminated the sprue and runner, which prevented the adhesive from bonding to the mold surface.

### Preparation of Molded Samples, Examples 1-7 (EX1-EX7)

### Example 1 (EX1)

Substrate 1 laser cut to 25 mm by 213 mm using a laser cutter machine (Model VLS6.60, available from Universal Laser Systems, Scottsdale, AZ). This was over-molded with VHB-XT.

Liner 1 was laser cut using the same laser cutter described above to dimensions of 51 mm by 254 mm, with a 3.1 mm hole, located preferably in the center to allow for injection through the liner. Liner 3 with one hole cut in the center (size and location as same as above) was statically pinned to the A-side half of the mold using an electrostatic generation unit (Chargemaster VCM, available from Simco ION, Hatfield, PA). The center hole, which allowed for adhesive to be injected into the mold cavity, was aligned with the heated channel and valve gate opening on the mold. The silicone release coating was oriented away from the cavity wall, so that the PSA was injected against the silicone coating.

VHB-XT was fed directly into the feed throat of a Krauss Maffei 65 Ton hydraulic injection molding machine with 28-mm barrel (Model KM65, Krauss Maffei, Munich, Germany). A general-purpose injection molding screw was used. VHB-XT was mounted on a stationary steel shaft with diameter of approximately 40 mm and 610 mm long. The spool was 34.3 cm diameter and 36.8 cm long, with a 54 mm inner diameter hole to accept the shaft. The spool was oriented horizontally approximately 0.5 m from the feed throat. Approximately every other molding cycle, the spool was manually rotated to reduce tension in the filament as it unwound.

Once the barrel and screw were at 190.5° C. (375° F.), material was purged through barrel to ensure no contamination from previous materials. The heated channel and valves were at 204.4° C. (400° F.). After static pinning Liner 1 to the A-side half, and static pinning Substrate 1 to the B-side half, the mold was closed and VHB-XT was injected into the mold cavity. Injection speed was 63.5 mm (2.5 in) per second. Pack pressure was 68.9 bar (1000 PSI) for 1 second. Injection pressure was 517 bar (7500 PSI). The screw shot was 31.8 mm (1.25 in). Material temperature was 190.5° C. (375° F.). The mold temperature was set to 15.5° C. (60° F.) and the material was allowed to cool for 20 seconds. The mold opened and the part was manually removed from the mold cavity. The same molding process conditions were used for each example.

### Example 2 (EX2)

The same procedure was followed as for Example 1, except that Liner 2 was used in place of Liner 1.

### Example 3 (EX3)

The same procedure was followed as for Example 1, except that Liner 3 was used in place of Liner 1.

### Example 4 (EX4)

The same procedure was followed as for Example 1, except that Substrate 2 was used in place of Substrate 1.

### Example 5 (EX5)

The same procedure was followed as for Example 2, except that Substrate 2 was used in place of Substrate 1.

### Example 6 (EX6)

The same procedure was followed for Example 3, except that Substrate 2 was used in place of Substrate 1.

### Example 7 (EX7)

The same procedure was followed for Example 1, except that Liner 3 was used in place of Substrate 1. This example demonstrates the concept of injecting between two removable liners, instead of injecting between a part and a liner. Both liners had the release coating oriented to be in contact with the PSA.

TABLE 2
Liners, Substrates, and PSAs used in Examples

| Example | Liner | Substrate | PSA |
|---|---|---|---|
| EX1 | Liner 1 | Substrate 1 | VHB-XT |
| EX2 | Liner 2 | Substrate 1 | VHB-XT |
| EX3 | Liner 3 | Substrate 1 | VHB-XT |
| EX4 | Liner 1 | Substrate 2 | VHB-XT |
| EX5 | Liner 2 | Substrate 2 | VHB-XT |
| EX6 | Liner 3 | Substrate 2 | VHB-XT |
| EX7 | Liner 1 | Liner 3 | VHB-XT |

### Results:

The Shear Viscosity measurements for VHB-XT at 190° C. were 772 Pa·s at 10 sec⁻¹, 256 Pa·s at 100 sec⁻¹, and 57.6 Pa·s at 1000 sec⁻¹. Additionally, VHB-XT passed Green Strength Test with 3 kg holding when closing bond within 20 sec.

### Select Embodiments of the Present Disclosure

Embodiment 1 is a method of injection molding of a pressure sensitive adhesive, comprising: providing a filament adhesive wherein the filament adhesive is a pressure sensitive adhesive; providing a first substrate having a first major surface; providing a liner having at least one hole; providing a mold for holding the first substrate and for forming an adhesive layer; heating the filament adhesive to provide a molten composition; heating the flow channel; injection molding the molten filament adhesive composition through the heated flow channel and through the at least one hole in the liner; molding an adhesive layer on the first major surface of the first substrate from the molten filament adhesive composition.

Embodiment 2 is a method of injection molding of a pressure sensitive adhesive, comprising: providing a filament adhesive wherein the filament adhesive is a pressure sensitive adhesive; providing a first substrate having a first major surface and a first minor surface; providing a liner; providing a mold for holding the first substrate and for forming an adhesive layer, wherein the mold has an flow channel located adjacent to the minor surface; heating the filament adhesive to provide a molten filament adhesive composition; heating the flow channel;
injection molding the molten filament adhesive composition through the heated flow channel; molding an adhesive layer on the first major surface of the first substrate from the molten filament adhesive composition.

Embodiment 3 is a method of injection molding of a pressure sensitive adhesive, comprising: providing a filament adhesive wherein the filament adhesive is a pressure sensitive adhesive; providing a first liner having a first major surface and at least one hole; providing a second liner having a first major surface; providing a mold for holding the first liner and the second liner and for forming an adhesive layer therebetween; heating the filament adhesive to provide a molten filament adhesive composition; heating the flow channel; injection molding the molten filament adhesive composition through the heated flow channel and through the at least one hole in the first liner; molding an adhesive layer on a first major surface of the first liner and on the first major surface of the second liner from the molten filament adhesive composition.

Embodiment 4 is a method of injection molding of a pressure sensitive adhesive, comprising: providing a filament adhesive wherein the filament adhesive is a pressure sensitive adhesive; providing a first liner having a first major surface; providing a second liner having a first major surface; providing a mold for holding the first liner and the second liner and for forming an adhesive layer therebetween; heating the filament adhesive to provide a molten filament adhesive composition; heating the flow channel; injection molding the molten filament adhesive composition through the heated flow channel between the first liner and the second liner; molding an adhesive layer on a first major surface of the first liner and on the first major surface of the second liner from the molten filament adhesive composition.

Embodiment 5 is a method of injection molding of a pressure sensitive adhesive, comprising: providing a filament adhesive wherein the filament adhesive is a pressure sensitive adhesive; providing a first substrate having a first major surface and a first minor surface; providing a second substrate having a first major surface and a first minor surface; providing a mold for holding the first substrate and the second substrate and for forming an adhesive layer therebetween; heating the filament adhesive to provide a molten filament adhesive composition; heating the flow channel; injection molding the molten filament adhesive composition through the heated flow channel and between the major surfaces of the first and second substrate; molding an adhesive layer on a first major surface of the first substrate and on the first major surface of the second substrate from the molten filament adhesive composition.

Embodiment 6 is a method of injection molding of a pressure sensitive adhesive, comprising: providing a filament adhesive wherein the filament adhesive is a pressure sensitive adhesive; providing a first substrate having a first major surface and at least one hole; providing a second substrate having a first major surface and a first minor surface; providing a mold for holding the first substrate and the second substrate and for forming an adhesive layer therebetween; heating the filament adhesive to provide a molten filament adhesive composition; heating the flow channel; injection molding the molten filament adhesive composition through the heated flow channel and through the at least one hole in the first substrate; molding an adhesive layer on a first major surface of the first liner and on the first major surface of the second liner from the molten filament adhesive composition.

Embodiment 7 is a method of injection molding of a pressure sensitive adhesive, comprising: providing a filament adhesive wherein the filament adhesive is a pressure sensitive adhesive; providing a thermoplastic material for molding a substrate; providing a first mold for molding the substrate and thereafter forming an adhesive layer on the substrate; injection molding the thermoplastic material into the first mold to form a first substrate having a first major surface; heating the filament adhesive to provide a molten filament adhesive composition; heating the flow channel; injection molding the molten filament adhesive composition through the heated flow channel; and molding an adhesive layer on a first major surface of the first substrate from the molten filament adhesive composition.

Embodiment 8 is a method of injection molding of a pressure sensitive adhesive, comprising: providing a filament adhesive wherein the filament adhesive is a pressure sensitive adhesive; providing a thermoplastic material for molding a substrate; providing a first mold for molding the substrate; injection molding the thermoplastic material into the first mold to form a first substrate having a first major surface; providing a second mold for holding the first substrate for forming an adhesive layer; heating the filament adhesive to provide a molten filament adhesive composition; heating the flow channel; injection molding the molten filament adhesive composition through the heated flow channel; and molding an adhesive layer on a first major surface of the first substrate from the molten filament adhesive composition.

Embodiment 9 is a method of injection molding of a pressure sensitive adhesive, comprising: providing a filament adhesive wherein the filament adhesive is a pressure sensitive adhesive; providing a first substrate having a first major surface; providing a liner having at least one hole; providing a mold for holding the first substrate and for forming an adhesive layer; heating the filament adhesive to provide a molten composition; heating a hot runner system; injection molding the molten filament adhesive composition through the heated hot runner system and through the at least one hole in the liner; and molding an adhesive layer on the first major surface of the first substrate from the molten filament adhesive composition.

Embodiment 10 is a method of injection molding of a pressure sensitive adhesive, comprising: providing a filament adhesive wherein the filament adhesive is a pressure sensitive adhesive; providing a first substrate having a first major surface and a first minor surface; providing a liner; providing a mold for holding the first substrate and for forming an adhesive layer, wherein the mold has an flow channel located adjacent to the minor surface; heating the filament adhesive to provide a molten filament adhesive composition; heating a hot runner system; injection molding the molten filament adhesive composition through the hot runner system and into the flow channel; and molding an adhesive layer on the first major surface of the first substrate from the molten filament adhesive composition.

Embodiment 11 is a method of injection molding of a pressure sensitive adhesive, comprising: providing a filament adhesive wherein the filament adhesive is a pressure sensitive adhesive; providing a first liner having a first major surface and at least one hole; providing a second liner having a first major surface; providing a mold for holding the first liner and the second liner and for forming an adhesive layer therebetween; heating the filament adhesive to provide a molten filament adhesive composition; heating a hot runner system; injection molding the molten filament adhesive composition through the hot runner system and through the at least one hole in the first liner; and molding an adhesive layer on a first major surface of the first liner and on the first major surface of the second liner from the molten filament adhesive composition.

Embodiment 12 is a method of injection molding of a pressure sensitive adhesive, comprising: providing a filament adhesive wherein the filament adhesive is a pressure sensitive adhesive; providing a first liner having a first major surface; providing a second liner having a first major surface; providing a mold for holding the first liner and the second liner and for forming an adhesive layer therebetween; heating the filament adhesive to provide a molten filament adhesive composition; heating a hot runner system; injection molding the molten filament adhesive composition through the hot runner system and between the first liner and the second liner; and molding an adhesive layer on a first major surface of the first liner and on the first major surface of the second liner from the molten filament adhesive composition.

Embodiment 13 is a method of injection molding of a pressure sensitive adhesive, comprising: providing a filament adhesive wherein the filament adhesive is a pressure sensitive adhesive; providing a first substrate having a first major surface and a first minor surface; providing a second substrate having a first major surface and a first minor surface; providing a mold for holding the first substrate and the second substrate and for forming an adhesive layer therebetween; heating the filament adhesive to provide a molten filament adhesive composition; heating the hot runner system; injection molding the molten filament adhesive composition through the hot runner system and between the major surfaces of the first and second substrate; and molding an adhesive layer on a first major surface of the first substrate and on the first major surface of the second substrate from the molten filament adhesive composition.

Embodiment 14 is a method of injection molding of a pressure sensitive adhesive, comprising: providing a filament adhesive wherein the filament adhesive is a pressure sensitive adhesive; providing a first substrate having a first major surface and at least one hole; providing a second substrate having a first major surface and a first minor surface; providing a mold for holding the first substrate and the second substrate and for forming an adhesive layer therebetween; heating the filament adhesive to provide a molten filament adhesive composition; heating the hot runner system; injection molding the molten filament adhesive composition through the hot runner system and through the at least one hole in the first substrate; and molding an adhesive layer on a first major surface of the first liner and on the first major surface of the second liner from the molten filament adhesive composition.

Embodiment 15 is a method of injection molding of a pressure sensitive adhesive, comprising: providing a filament adhesive wherein the filament adhesive is a pressure sensitive adhesive; providing a thermoplastic material for molding a substrate; providing a first mold for molding the substrate and thereafter forming an adhesive layer on the substrate; injection molding the thermoplastic material into the first mold to form a first substrate having a first major surface; heating the filament adhesive to provide a molten filament adhesive composition; heating a hot runner system; injection molding the molten filament adhesive composition through the hot runner system; and molding an adhesive layer on a first major surface of the first substrate from the molten filament adhesive composition.

Embodiment 16 is a method of injection molding of a pressure sensitive adhesive, comprising: providing a filament adhesive wherein the filament adhesive is a pressure sensitive adhesive; providing a thermoplastic material for molding a substrate; providing a first mold for molding the substrate; injection molding the thermoplastic material into the first mold to form a first substrate having a first major surface; providing a second mold for holding the first substrate for forming an adhesive layer; heating the filament adhesive to provide a molten filament adhesive composition; heating a hot runner system; injection molding the molten filament adhesive composition through the hot runner system; molding an adhesive layer on a first major surface of the first substrate from the molten filament adhesive composition.

Embodiment 17 is the methods of Embodiments 1-16, further comprising: masticating the filament adhesive prior to the heating step to provide a molten composition.

Embodiment 18 is the methods of Embodiment 17, further comprising: mixing and plasticizing the molten composition prior to the injection molding step, wherein the mixing step is in a nozzle.

Embodiment 19 is the methods of Embodiment 1-16, wherein the pressure sensitive adhesive is a non-reactive thermoplastic pressure sensitive adhesive, and the liner is a silicone coated liner.

Embodiment 20 is the methods of Embodiment 1-16, wherein the filament adhesive comprises a pressure-sensitive adhesive core that is viscoelastic at ambient temperature.

Embodiment 21 is the methods of Embodiment 1-16, wherein the filament adhesive comprises a sheath that is non-tacky at ambient temperature.

Embodiment 22 is the methods of Embodiments 1-16, wherein the filament adhesive comprises a sheath that is non-tacky up to 50° C.

Embodiment 23 is the methods of Embodiments 1-16, wherein the mold includes mold cavity walls shaped to provide the layer of adhesive on the substrate in a desired molded shape.

Embodiment 24 is the methods of Embodiments 1-16, wherein the mold cavity walls include at least a chamfer or a radius.

Embodiment 25 is the methods of Embodiment 24, wherein the chamfered side walls are chamfered 10-70 degrees relative to a major surface of the mold cavity.

Embodiment 26 is the methods of Embodiments 1-16, wherein the liner comprises polyethylene terephthalate or polypropylene.

Embodiment 27 is the methods of Embodiment 1-16, wherein the pressure sensitive adhesive comprises a styrenic block copolymer and a tackifier.

Embodiment 28 is the methods of Embodiments 1-16, wherein the pressure sensitive adhesive includes a melt viscosity range of 10 Pascal-Seconds to 10000 Pascal-Seconds at 190° C. and shear rates between 10 s\hat{ }−1 and 10000 s\hat{ }−1.

Embodiment 29 is the methods of Embodiment 28, wherein the pressure sensitive adhesive includes a melt viscosity range of 50 Pascal-Seconds to 8000 Pascal-Seconds at 190° C. and shear rates between 50 s\hat{ }−1 and 8000 s\hat{ }−1.

Embodiment 30 is the methods of Embodiments 1-16, wherein the pressure sensitive adhesive includes rapid green strength by holding a 3 kg weight when a 12.7 mm×25 mm×1 mm PSA bond between anodized aluminum plates within 20 seconds of dispensing, and the bond does not fail for the first 2 minutes.

Embodiment 31 is the methods of Embodiments 1-16, wherein the pressure sensitive adhesive includes rapid green strength as defined by a passing result for the Green Strength Test Method.

Embodiment 32 is the methods of Embodiments 1, 3, 8 and 10, wherein the liner includes a plurality of holes and the mold has a plurality of flow channels each aligned with one of the holes, wherein the method further comprises: heating the plurality of flow channels; and injection molding the filament adhesive through the heated plurality of flow channels and through the plurality of holes in the liner.

Embodiment 33 is the method of Embodiment 1-2, 5-8, and 13-16 further comprising:
removing the substate with a layer of pressure sensitive adhesive molded on its first major surface from the mold.

Embodiment 34 is a substrate with a layer of pressure sensitive adhesive molded on the substrate made by the methods of Embodiment 33.

Embodiment 35 is the substrate of Embodiment 34, wherein the substate is affiliated with electronics.

Embodiment 36 is the substrate of Embodiment 34, wherein the substrate is affiliated with appliances.

Embodiment 37 is the substrate of Embodiment 34, wherein the substrate is affiliated with automotive applications.

Embodiment 38 is the substrate of Embodiment 34, wherein the substrate is affiliated with consumer applications.

Embodiment 39 is the method of Embodiments 6 and 14 wherein the first substrate includes a plurality of holes and the mold has a plurality of flow channels each aligned with one of the holes, wherein the method further comprises: heating the plurality of flow channels; and injection molding the filament adhesive through the heated plurality of flow channels and through the plurality of holes in the first substrate.

Embodiment 40 is the method of Embodiments 3-4 and 11-12 further comprising: removing the substate with a layer of pressure sensitive adhesive molded on its first major surface from the mold.

Embodiment 41 is a substrate with a layer of pressure sensitive adhesive molded on the substrate made by the methods of Embodiment 40.

Embodiment 42 is the substrate of Embodiment 41, wherein the substate is to be used in an electronic device.

Embodiment 43 is the substrate of Embodiment 41, wherein the substrate is to be used in an appliance.

Embodiment 44 is the substrate of Embodiment 41, wherein the substrate is to be used in an automotive.

Embodiment 45 is the substrate of Embodiment 41, wherein the substrate is to be used in a consumer device.

1. A method of injection molding of a pressure sensitive adhesive, comprising:
providing a filament adhesive wherein the filament adhesive is a pressure sensitive adhesive;
providing a first substrate having a first major surface;
providing a liner having at least one hole;
providing a mold for holding the first substrate and for forming an adhesive layer;
heating the filament adhesive to provide a molten composition;
heating a flow channel;
injection molding the molten filament adhesive composition through the heated flow channel and through the at least one hole in the liner; and
molding an adhesive layer on the first major surface of the first substrate from the molten filament adhesive composition.

2-16. (canceled)

17. The method of claim 1, further comprising:
masticating the filament adhesive prior to the heating step to provide a molten composition.

18. The method of claim 17, further comprising:
mixing and plasticizing the molten composition prior to the injection molding step, wherein the mixing step is in a nozzle.

19. The method of claim 1, wherein the pressure sensitive adhesive is a non-reactive thermoplastic pressure sensitive adhesive, and the liner is a silicone coated liner.

20. The method of claim 1, wherein the filament adhesive comprises a pressure-sensitive adhesive core that is viscoelastic at ambient temperature.

21. The method of claim 1, wherein the filament adhesive comprises a sheath that is non-tacky at ambient temperature.

22. The method of claim 1, wherein the filament adhesive comprises a sheath that is non-tacky up to 50° C.

23. The method of claim 1, wherein the mold includes mold cavity walls shaped to provide the layer of adhesive on the substrate in a desired molded shape.

24. The method of claim 1, wherein the mold cavity walls include at least a chamfer or a radius.

25. The method of claim 24, wherein the chamfered side walls are chamfered 10-70 degrees relative to a major surface of the mold cavity.

26. The method of claim 1, wherein the liner comprises polyethylene terephthalate or polypropylene.

27. The method of claim 1, wherein the pressure sensitive adhesive comprises a styrenic block copolymer and a tackifier.

28. The method of claim 1, wherein the pressure sensitive adhesive includes a melt viscosity range of 10 Pascal-Seconds to 10000 Pascal-Seconds at 190° C. and shear rates between 10 s\hat{ }−1 and 10000 s\hat{ }−1.

29. The method of claim 28, wherein the pressure sensitive adhesive includes a melt viscosity range of 50 Pascal-Seconds to 8000 Pascal-Seconds at 190° C. and shear rates between 50 s\hat{ }−₁ and 8000 s\hat{ }−1.

30. The method of claim 1, wherein the pressure sensitive adhesive includes rapid green strength by holding a 3 kg weight when a 12.7 mm×25 mm×1 mm PSA bond between anodized aluminum plates within 20 seconds of dispensing, and the bond does not fail for the first 2 minutes.

31. The method of claim 1, wherein the pressure sensitive adhesive includes rapid green strength as defined by a passing result for the Green Strength Test Method.

32. The method of claim 1, wherein the liner includes a plurality of holes and the mold has a plurality of flow channels each aligned with one of the holes, wherein the method further comprises:
heating the plurality of flow channels; and
injection molding the filament adhesive through the heated plurality of flow channels and through the plurality of holes in the liner.

33. The method of claim 1 further comprising:
removing the substate with a layer of pressure sensitive adhesive molded on its first major surface from the mold.

34. A substrate with a layer of pressure sensitive adhesive molded on the substrate made by the methods of claim 33.

35-45. (canceled)
